(19) United States
(12) Patent Application Publication
(10) Pub. No.: US 2024/0297308 A1
(43) Pub. Date: Sep. 5, 2024

(54) BINDER, LIQUID COMPOSITION, STORAGE CONTAINER, ELECTRODE PRODUCTION DEVICE, ELECTRODE PRODUCTION METHOD, ELECTRODE, ELECTROCHEMICAL ELEMENT, DEVICE, AND MOVING BODY

(71) Applicants: Toshiya Sagisaka, Kanagawa (JP); Kayato Ohya, Kanagawa (JP); Ryuji Higashi, Kanagawa (JP); Soh Noguchi, Kanagawa (JP)

(72) Inventors: Toshiya Sagisaka, Kanagawa (JP); Kayato Ohya, Kanagawa (JP); Ryuji Higashi, Kanagawa (JP); Soh Noguchi, Kanagawa (JP)

(73) Assignee: Ricoh Company, Ltd., Tokyo (JP)

(21) Appl. No.: 18/593,182

(22) Filed: Mar. 1, 2024

(30) Foreign Application Priority Data
Mar. 3, 2023 (JP) 2023-032470
Jan. 12, 2024 (JP) 2024-003405

(51) Int. Cl. H01M 4/62; H01M 4/02; H01M 4/04; H01M 4/1391; H01M 4/1397; H01M 4/485; H01M 4/58; H01M 10/0562

(52) U.S. Cl. CPC H01M 4/622; H01M 4/0407; H01M 4/1391; H01M 4/1397; H01M 4/485; H01M 4/5825; H01M 10/0562; H01M 2004/028; H01M 2300/0068

(57) ABSTRACT

A binder used in a liquid composition containing at least one of a positive electrode active material and a solid electrolyte is provided. The binder includes a structural unit (a) and a structural unit (b) each having specific chemical structures, and a composition ratio (a:b) of the structural unit (a) and the structural unit (b) ranges from “more than 0 mol %:less than 100 mol %” to “100 mol % or less:0 mol % or more”.

### CROSS-REFERENCE TO RELATED APPLICATIONS

This patent application is based on and claims priority pursuant to 35 U.S.C. § 119(a) to Japanese Patent Application Nos. 2023-032470 and 2024-003405, filed on Mar. 3, 2023 and Jan. 12, 2024, respectively, in the Japan Patent Office, the entire disclosure of each of which is hereby incorporated by reference herein.

### BACKGROUND

### Technical Field

The present disclosure relates to a binder, a liquid composition, a storage container, an electrode production device, an electrode production method, an electrode, an electrochemical element, a device, and a moving body.

### Related Art

Demand for electrochemical elements such as lithium ion secondary batteries is increasing as a result of being installed in mobile devices, hybrid vehicles, electric vehicles, and the like. Additionally, the need for thin batteries to be installed in various wearable devices or medical patches is increasing, and the demand for electrochemical elements is becoming increasingly diverse.

A liquid composition for an electrode composite layer for producing an electrode constituting an electrochemical element generally contains an active material, a dispersion medium, and a binder for obtaining binding properties in the resulting electrode composite layer. In general, because a polymer is used as the binder, and from the viewpoint of improving productivity, because the liquid composition for an electrode composite layer is prepared with a high solid content concentration, the binder is a slurry having a very high viscosity of 10³ mPa·s to 104 m·Pa·s. Therefore, in a conventional electrode production method of an electrode constituting an electrochemical element, for example, an electrode composite layer is formed on an electrode base by applying a liquid composition for an electrode composite layer using a die coater, a comma coater, a reverse roll coater, or the like. Furthermore, an electrode composite layer can also be formed by screen printing a liquid composition for an electrode composite layer on an electrode base.

However, in order to perform screen printing of a shape according to a need, it is preferable to prepare a plate according to each type of need. Therefore, a method has been proposed in which an electrode composite layer is formed by discharging a liquid composition for an electrode composite layer onto an electrode base using a liquid discharging device.

Such a liquid discharging method is a method in which fine droplets of a liquid composition are discharged from a discharge hole in a liquid discharging head in the liquid discharging device. Examples of methods for discharging droplets from a liquid discharging head include, but are not limited to, a piezo method, a thermal method, and a valve method. Among these methods, the piezo method has the advantage that, in addition to being able to accurately control the discharge amount of the liquid composition by controlling the voltage, the effect of the usage environment is low, and the durability is high because heating is not performed.

The liquid composition that is discharged by the liquid discharging method includes, for example, an active material, a conductive aid, and a binder, as well as a dispersant, a solvent, and the like, which are preferable for stably maintaining the liquid composition that is discharged.

However, there is a concern that the addition of a dispersant and a binder may cause deterioration of the electrochemical properties of the electrochemical element. Therefore, a reduction in the usage amounts of the dispersant and binder is desirable, and in particular, it is preferable that the strength of the electrode composite layer with respect to detachment and bending is maintained, even with a small usage amount of the binder.

### SUMMARY

A binder according to an embodiment of the present invention is used in a liquid composition containing at least one of a positive electrode active material and a solid electrolyte, wherein the binder includes a structural unit (a) represented by general formula (I) below, and a structural unit (b) represented by general formula (II) below, and a composition ratio (a:b) of the structural unit (a) represented by the general formula (I) and the structural unit (b) represented by the general formula (II) ranges from “more than 0 mol %:less than 100 mol %” to “100 mol % or less: 0 mol % or more”.

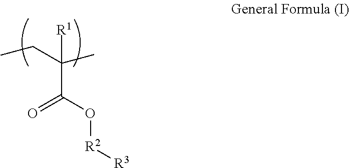

In the general formula (I), R¹ represents a hydrogen atom or an alkyl group, R² represents an alkylene group having 1 or more carbon atoms, and R³ represents a tertiary amino group.

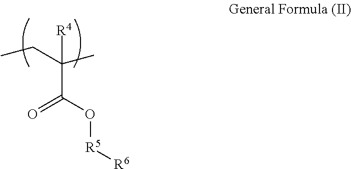

In the general formula (II), R⁴ represents a hydrogen atom or an alkyl group, R⁵ represents an alkylene group having 1 to 7 carbon atoms, both inclusive, or an alkylene oxide group having a total number of carbon and oxygen atoms of 1 or more and 7 or less, and R⁶ represents a hydrogen atom, a methyl group, or an ethyl group.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an electrode production method according to an embodiment of the present invention;

FIG. 2 is a schematic diagram illustrating an electrode production device according to an embodiment of the present invention;

FIG. 3 is a schematic diagram illustrating an electrode production device according to an embodiment of the present invention;

FIG. 4 is a schematic diagram illustrating an electrode production method according to an embodiment of the present invention;

FIG. 5 is a schematic diagram illustrating a modification of a liquid discharging device;

FIG. 6 is a schematic diagram illustrating an electrode production method according to an embodiment of the present invention;

FIG. 7 is a schematic diagram illustrating a modification of a liquid discharging device;

FIG. 8 is a cross-sectional view of a negative electrode according to an embodiment of the present invention;

FIG. 9 is a cross-sectional view of a positive electrode according to an embodiment of the present invention;

FIG. 10 is a cross-sectional view of an electrode according to an embodiment of the present invention;

FIG. 11 is a cross-sectional view of an electrode according to an embodiment of the present invention;

FIG. 12 is a cross-sectional view of an electrode element used in an electrochemical element according to an embodiment of the present invention;

FIG. 13 is a cross-sectional view of an electrochemical element according to an embodiment of the present invention;

FIG. 14 is a schematic diagram illustrating a moving body installed with an all-solid state battery, which is an electrochemical element according to an embodiment of the present invention; and

FIG. 15 is a graph illustrating measurement results of the peel strength in Example 6.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, a binder is provided that is used in a liquid composition containing at least one of a positive electrode active material and a solid electrolyte, that can impart superior binding properties and bending resistance to at least one of an electrode composite layer and a solid electrolyte layer.

### (Binder)

A binder of the present embodiment is used in a liquid composition containing at least one of a positive electrode active material and a solid electrolyte. The binder includes a structural unit (a) represented by general formula (I) below, and a structural unit (b) represented by general formula (II) below, and a composition ratio (a:b) of the structural unit (a) represented by the general formula (I) and the structural unit (b) represented by the general formula (II) ranges from “more than 0 mol %:less than 100 mol %” to “100 mol % or less: 0 mol % or more”.

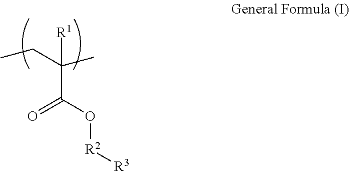

In the general formula (I), R¹ represents a hydrogen atom or an alkyl group, R² represents an alkylene group having 1 or more carbon atoms, and R³ represents a tertiary amino group.

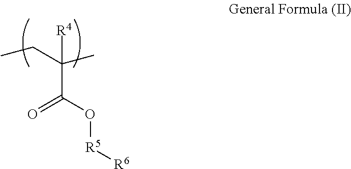

In the general formula (II), R⁴ represents a hydrogen atom or an alkyl group, R⁵ represents an alkylene group having 1 to 7 carbon atoms, both inclusive, or an alkylene oxide group having a total number of carbon and oxygen atoms of 1 or more and 7 or less, and R⁶ represents a hydrogen atom, a methyl group, or an ethyl group.

The binder of the present embodiment is used in a liquid composition containing at least one of a positive electrode active material and a solid electrolyte.

A liquid composition containing a positive electrode active material, a liquid composition containing a positive electrode active material and a solid electrolyte, and a liquid composition containing a negative electrode active material and a solid electrolyte are used as a liquid composition for an electrode composite layer, and are used to form an electrode composite layer of an electrochemical element.

A liquid composition containing a solid electrolyte is used as a liquid composition for a solid electrolyte layer, and is used to form a solid electrolyte layer of an electrochemical element.

As a result of the binder of the present embodiment including the structural unit (a) represented by the general formula (I) above and the structural unit (b) represented by the general formula (II) above, and a composition ratio (a:b) of the structural unit (a) represented by the general formula (I) and the structural unit (b) represented by the general formula (II) ranging from “more than 0 mol %:less than 100 mol %” to “100 mol % or less: 0 mol % or more”, it is possible to form at least one of an electrode composite layer and a solid electrolyte layer having superior bending resistance and binding properties.

R¹ and R⁴ in the general formula (I) and the general formula (II) above represent a hydrogen atom or an alkyl group.

The alkyl group is preferably a substituted or unsubstituted alkyl group, and from the viewpoint of the film strength, is more preferably an alkyl group having 1 to 30 carbon atoms, even more preferably an alkyl group having 1 to 18 carbon atoms, particularly preferably an alkyl group having 1 to 10 carbon atoms, and most preferably is a methyl group having one carbon atom. Note that the alkyl group may be either a straight chain or branched chain alkyl group.

Examples of the alkyl group having 1 to 30 carbon atoms include, but are not limited to, a methyl group, an ethyl group, a propyl group, a butyl group, an isopropyl group, an isobutyl group, a pentyl group, a hexyl group, a heptyl group, an ethylhexyl group, an octyl group, a decyl group, a dodecyl group, a 2-butyloctyl group, and an octadecyl group.

The substituent is not particularly limited and can be appropriately selected according to the intended purpose. Examples of the substituent include, but are not limited to, a halogen atom, a cyano group, an alkyl group having 1 to 12 carbon atoms, a phenyl group, a phenyl group substituted with a cycloalkyl group having 3 to 12 carbon atoms or an alkoxy group having 1 to 12 carbon atoms, a hydroxyl group, and a carboxyl group. A plurality of the same substituents may be introduced, or a plurality of different substituents may be introduced.

R³ in the general formula (I) represents a tertiary amino group.

The tertiary amino group is preferably an amino group substituted with an alkyl group or an aryl group, and from the viewpoint of the electrochemical stability, is more preferably an amino group substituted with an alkyl group.

The alkyl group bonded to the nitrogen of the tertiary amino group is preferably a substituted or unsubstituted alkyl group, and from the viewpoint of the film strength, is more preferably an alkyl group having 1 to 30 carbon atoms, even more preferably an alkyl group having 1 to 18 carbon atoms, particularly preferably an alkyl group having 1 to 10 carbon atoms, and most preferably is a methyl group having one carbon atom.

Furthermore, from the viewpoint of the bending resistance, the alkyl group is preferably a substituted or unsubstituted alkyl group, and from the viewpoint of the film strength, is more preferably an alkyl group having 1 to 30 carbon atoms, even more preferably an alkyl group having 1 to 18 carbon atoms, particularly preferably an alkyl group having 1 to 10 carbon atoms, and most preferably is an ethyl group having two carbon atoms.

Note that the alkyl group may be either a straight chain or branched chain alkyl group.

Examples of the alkyl group having 1 to 30 carbon atoms include, but are not limited to, a methyl group, an ethyl group, a propyl group, a butyl group, an isopropyl group, an isobutyl group, a pentyl group, a hexyl group, a heptyl group, an ethylhexyl group, an octyl group, a decyl group, a dodecyl group, a 2-butyloctyl group, and an octadecyl group.

The substituent is not particularly limited and can be appropriately selected according to the intended purpose. Examples of the substituent include, but are not limited to, a halogen atom, a cyano group, an alkyl group having 1 to 12 carbon atoms, a phenyl group, a phenyl group substituted with a cycloalkyl group having 3 to 12 carbon atoms or an alkoxy group having 1 to 12 carbon atoms, a hydroxyl group, and a carboxyl group. A plurality of the same substituents may be introduced, or a plurality of different substituents may be introduced.

The two alkyl groups bonded to the nitrogen of the tertiary amino group may be the same or different, and may be bonded to each other to form a ring.

Examples of the tertiary amino group include, but are not limited to, a dimethylamino group, a diethylamino group, a methylethylamino group, a dipropylamino group, a diisopropylamino group, a cyclohexylamino group, and a morpholino group.

R² in the general formula (I) represents an alkylene group having 1 or more carbon atoms, and preferably represents an alkylene group having 1 to 20 carbon atoms.

Examples of the alkylene group include, but are not limited to, divalent groups of the alkyl groups described above, such as a linear alkylene group, a branched alkylene group, and a cycloalkylene group.

Examples of the straight chain alkylene group include, but are not limited to, a methylene group, an ethylene group, a propylene group, an n-butylene group, and an n-pentylene group.

A branched alkylene group is a group in which at least one hydrogen atom of the linear alkylene groups described above is substituted with an alkyl group. Examples of the branched alkylene group include, but are not limited to, a methylmethylene group, an ethylmethylene group, a propylmethylene group, a butylmethylene group, a methylethylene group, an ethylethylene group, a propylethylene group, a methylpropylene group, a 2-ethylpropylene group, a dimethylpropylene group, and a methylbutylene group.

Examples of the cycloalkylene group include, but are not limited to, a monocyclic cycloalkylene group, a bridged ring cycloalkylene group, and a fused ring cycloalkylene group.

Examples of the monocyclic cycloalkylene group include, but are not limited to, a cyclopentylene group.

R⁵ in the general formula (II) above represents an alkylene group having 1 to 7 carbon atoms, both inclusive, or an alkylene oxide group having a total number of carbon and oxygen atoms of 1 or more and 7 or less.

When the number of carbon atoms in the alkylene group represented by R⁵ is 1 or more and 7 or less, the polymer is a solid and can function as a binder. On the other hand, when the number of carbon atoms exceeds 7, the polymer tends to become a liquid and the function as a binder is lost.

The alkylene oxide group is represented by the following general formula.

—(RO)ₙ—
(in the general formula, R represents an alkylene group, and n represents an integer of 1 or more)

The alkylene group represented by R is the same as the alkylene group represented by R⁵, but an ethylene group or a propylene group are most preferable.

R⁶ in the general formula (II) represents a hydrogen atom, a methyl group, or an ethyl group.

When R⁶ is a hydrogen atom and R⁵ is an alkylene oxide group, the terminal group of the group represented by connecting R⁵ and R⁶ becomes a hydroxyl group, and an improvement in the binding properties is expected. On the other hand, when a sulfide solid electrolyte is used, if R⁶ is an alkyl group such as a methyl group or an ethyl group, the possibility of adverse effects is reduced and an improvement in the characteristics is expected.

In addition, when the group represented by R⁵ and R⁶ bonded together is an alkyl group, an alkyl group having 4 or less carbon atoms is preferable from the viewpoint of the peel strength due to a difference in glass transition points, and an alkyl group having 4 or more carbon atoms is preferable from the viewpoint of the bending resistance due to a difference in glass transition points. Among such alkyl groups, an alkyl group having 4 carbon atoms is preferable from the viewpoint of achieving both a good peel strength and bending resistance.

The composition ratio (a:b) of the structural unit (a) represented by the general formula (I) and the structural unit (b) represented by the general formula (II) ranges from “more than 0 mol %:less than 100 mol %” to “100 mol % or less: 0 mol % or more”, is preferably “10 mol %: 90 mol %” to “90 mol %: 10 mol %”, and more preferably “10 mol %: 90 mol %” to “40 mol %: 60 mol %”.

When the composition ratio (a:b) is “more than 0 mol %:less than 100 mol %” to “100 mol % or less: 0 mol % or more”, it is possible to form at least one of an electrode composite layer and a solid electrolyte layer having superior bending resistance and binding properties. When the composition ratio (a:b) is “10 mol %: 90 mol %” to “40 mol %: 60 mol %”, that is, when the amount of the structural unit (a) having the tertiary amino group is lower than that of the structural unit (b) in the composition, a decrease in Tg can be suppressed, and good peel strength can be obtained.

In addition to the structural unit represented by the general formula (I) and the structural unit represented by the general formula (II), the binder can include repeating units derived from other polymerizable monomers.

The other polymerizable monomers are not particularly limited and can be appropriately selected according to the intended purpose.

The weight average molecular weight of the binder is preferably 1,000 to 1,000,000, more preferably 2,000 to 700,000, and even more preferably 100,000 to 350,000 in terms of polystyrene by gel permeation chromatography (GPC). If the weight average molecular weight is too small, the film forming properties will deteriorate, resulting in cracks and the like, and the film will have poor practicality. On the other hand, if the weight average molecular weight is too large, the solubility in general organic solvents will be poor and the viscosity of the solution will be high, making it difficult to apply the liquid composition, which poses a practical problem.

The glass transition temperature of the binder is preferably −30° C. or higher and less than 70° C., and more preferably −15° C. or higher and less than 40° C. A glass transition temperature less than −30° C. is effective in terms of the bending resistance, but the film may become brittle and the peel strength may become weak. On the other hand, if the glass transition temperature is 70° C. or higher, the bending resistance and cutting resistance will deteriorate, which can pose a practical problem.

The glass transition temperature is the glass transition temperature measured by DSC. Specifically, a sample is cooled to −80° C. under a nitrogen stream, heated to 200° C. at 10° C./min, and then cooled again to −60° C. at 10° C./min. The glass transition temperature can be determined from a curve measured during the final heating procedure when the temperature is raised again to 200° C. at 10° C./min.

The synthesis method of the binder of the present embodiment is not particularly limited and can be appropriately selected according to the intended purpose. The binder can be synthesized by polymerizing a monomer containing the structural unit represented by the general formula (I) above, or by polymerizing a monomer containing the structural unit represented by the general formula (I) above and a monomer containing the structural unit represented by the general formula (II) above.

Examples of the binder of the present embodiment include, but are not limited to, the binders shown below. However, the binder is not limited to these examples.

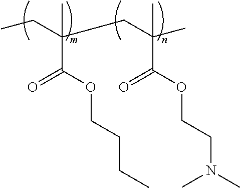

The subscripts m and n in parentheses in the formula above represent the molar ratio of the constituent components. The ratio m/n is preferably 0.5/0.5 to 0.9/0.1.

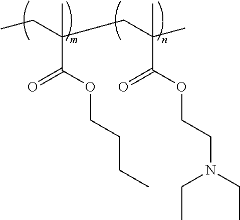

The subscripts m and n in parentheses in the formula above represent the molar ratio of the constituent components. The ratio m/n is preferably 0.5/0.5 to 0.9/0.1.

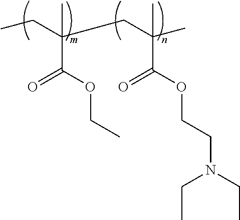

The subscripts m and n in parentheses in the formula above represent the molar ratio of the constituent components. The ratio m/n is preferably 0.5/0.5 to 0.9/0.1.

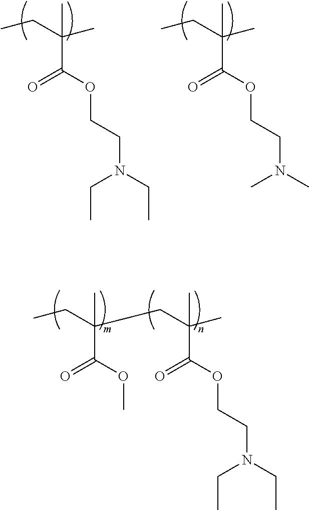

The subscripts m and n in parentheses in the formula above represent the molar ratio of the constituent components. The ratio m/n is preferably 0.5/0.5 to 0.9/0.1.

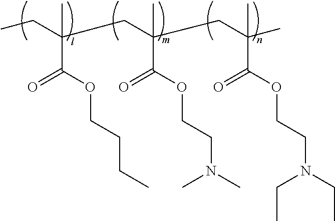

The subscripts 1, m and n in parentheses in the formula above represent the molar ratio of the constituent components. The ratio l:m:n is preferably 0.5 to 0.9:0.25 to 0.05:0.25 to 0.05 (however, l+m+n=1).

### (Liquid Composition)

The liquid composition of the present embodiment contains at least one of a positive electrode active material and a solid electrolyte, a binder, and a solvent, and other components if preferable.

The liquid composition of the present embodiment containing the binder of the present embodiment described above is capable of forming at least one of an electrode composite layer and a solid electrolyte layer having superior bending resistance and binding properties.

The liquid composition of the present embodiment can be preferably used as a liquid composition for inkjet discharge.

The liquid composition of the present embodiment is a liquid composition that is used to form at least one of an electrode composite layer and a solid electrolyte layer of an electrode of an electrochemical element, and can be used, for example, as a liquid composition for forming an electrode composite layer of a secondary battery or a liquid composition for forming a solid electrolyte layer of a secondary battery.

The liquid composition for forming an electrode composite layer of a secondary battery can be used, for example, when forming an electrode composite layer (positive electrode composite layer or negative electrode composite layer) of a non-aqueous secondary battery such as a lithium ion secondary battery.

The liquid composition for forming a solid electrolyte layer of a secondary battery can be used, for example, when forming a solid electrolyte layer of a non-aqueous secondary battery such as a lithium ion secondary battery.

### <Liquid Composition for Forming Electrode Composite Layer>

The liquid composition for forming an electrode composite layer contains a positive electrode active material, a solid electrolyte, a binder, and a solvent, and other additional components if preferable.

### <<Binder>>

As the binder, the above-described binder of the present embodiment described is used.

The binder is preferably blended within a mass concentration range that dissolves in the solvent used in the liquid composition. When the binder is blended within a mass concentration range that dissolves in the solvent used in the liquid composition, it is relatively easy to reduce the viscosity, and because the insoluble polymer particles in the liquid composition do not bind to pigments such as ion-conductive materials, superior storage stability and redispersibility are obtained.

The mass concentration range within which the binder dissolves in the solvent refers to a range within which the binder is compatible with the solvent. More specifically, the mass concentration is within a range in which no sediment or supernatant is visually observed after the binder is placed in the solvent at a temperature of 25° C., and then dissolved and left to stand for 10 minutes.

Note that the conditions for dissolving the binder are not particularly limited as long as the binder is dissolved.

The binder is a component that does not excessively increase the viscosity of the liquid composition. Therefore, the liquid composition according to the present embodiment can be preferably used as a liquid composition for inkjet discharge. Furthermore, in an electrode produced by forming an electrode composite layer on an electrode base (current collector) using the liquid composition, the binder is a component that holds the components included in the electrode composite layer so as to not separate from the electrode composite layer (that is, functions as a binding agent).

The upper limit of the content of the binder in the liquid composition is preferably 10% by mass or less, more preferably 5% by mass or less, and even more preferably 3% by mass or less with respect to the positive electrode active material, and the lower limit is preferably 1% by mass or more. When the content of the binder is within the preferable range, it is possible to obtain a liquid composition in which the resulting electrode composite layer has a sufficiently high peel strength.

### <Active Material>

Examples of the active material include, but are not limited to, positive electrode active materials and negative electrode active materials that can be applied to an electrochemical element.

### [Positive Electrode Active Material]

The positive electrode active material is not particularly limited as long as it is capable of inserting or releasing alkali metal ions, and can be appropriately selected according to the intended purpose. For example, an alkali metal-containing transition metal compound can be used.

The alkali metal-containing transition metal compound is not particularly limited and can be appropriately selected according to the intended purpose, and examples include, but are not limited to, lithium-containing transition metal oxides such as composite oxides containing lithium and one or more elements selected from the group consisting of cobalt, manganese, nickel, chromium, iron, and vanadium.

The lithium-containing transition metal oxide is not particularly limited and can be appropriately selected according to the intended purpose, and examples include, but are not limited to, positive electrode active materials such as lithium-containing cobalt oxide (LiCoO₂), lithium manganate (LiMn₂O₄), lithium-containing nickel oxide (LiNiO₂), lithium-containing Co—Ni—Mn composite oxide (Li(CoMnNi)O₂), lithium-containing Ni—Mn—Al composite oxide, lithium-containing Ni—Co—Al composite oxide, olivine-type lithium iron phosphate (LiFePO₄), olivine-type lithium manganese phosphate (LiMnPO₄), Li₂MnO₃—LiNiO₂-based solid solution, lithium-excess spinel compounds represented by Li₁₊ₓMn₂₋ₓO₄ (0<X<2), Li[Ni_{0.17}Li_{0.2}Co_{0.07}Mn_{0.56}]O₂, and LiNi_{0.5}Mn_{1.5}O₄.

As the alkali metal-containing transition metal compound, a polyanionic compound having XO₄ tetrahedra (X=P, S, As, Mo, W, Si, and the like) in the crystal structure can also be used. Among such compounds, lithium-containing transition metal phosphate compounds such as lithium iron phosphate and lithium vanadium phosphate are preferable from the viewpoint of the cycling characteristics, and lithium vanadium phosphate is particularly preferable from the viewpoint of the lithium diffusion coefficient and the input/output characteristics of the electrochemical element.

Note that, from the viewpoint of the electronic conductivity, it is preferable that the surface of the polyanionic compound is coated with a conductive aid such as a carbon material to form a composite.

When the active material contains lithium, the solvent is preferably a non-aqueous solvent. In this case, the content of water in the liquid composition is preferably 5% by mass or less, and more preferably 1% by mass or less. If the content of water in the liquid composition is 5% by mass or less, a reduction in the discharge capacity of the electrochemical element caused by the lithium contained in the active material reacting with water and form compounds such as lithium carbonate can be suppressed. Furthermore, it is possible to suppress the decomposition of compounds such as lithium carbonate and the generation of gas during the charging and discharging of the electrochemical element.

### [Negative Electrode Active Material]

The negative electrode active material is not particularly limited as long it is capable of inserting or releasing alkali metal ions, and can be appropriately selected according to the intended purpose. For example, carbon materials containing graphite having a graphite-type crystal structure can be used.

Examples of the carbon material include, but are not limited to, natural graphite, artificial graphite, non-graphitizable carbon (hard carbon), and easily graphitizable carbon (soft carbon).

Examples of the negative electrode active material other than carbon materials include, but are not limited to, lithium titanate and titanium oxide.

Furthermore, when using an electrochemical element using a non-aqueous electrolyte, from the viewpoint of the energy density, it is preferable to use high-capacity materials such as silicon, tin, silicon alloy, tin alloy, silicon oxide, silicon nitride, and tin oxide as the negative electrode active material.

### [Maximum Particle Diameter of Active Material]

The maximum particle diameter of the active material of the present embodiment is not particularly limited as long the effects of the present embodiment are not impaired, and can be appropriately selected according to the intended purpose. However, the maximum particle diameter is preferably smaller than the nozzle diameter of the inkjet head, and is preferably sufficiently smaller than the nozzle diameter of the inkjet head from the viewpoint of allowing the inkjet discharging properties to be further improved. Specifically, the ratio between the maximum particle diameter of the active material contained in the liquid composition and the nozzle diameter of the inkjet head (maximum particle diameter of active material contained in liquid composition/nozzle diameter of inkjet head) is preferably 0.8 or less, more preferably 0.6 or less, and even more preferably 0.5 or less. When the maximum particle diameter of the active material is within these ranges, the discharging stability of the liquid composition is improved. For example, in the case of a droplet observation device (EV1000, manufactured by Ricoh Co., Ltd.), the nozzle diameter is 40 μm. Here, the maximum particle diameter of the active material contained in the liquid composition is preferably 32 μm or less, more preferably 24 μm or less, and even more preferably 20 μm or less. Note that the maximum particle diameter is the diameter that is the maximum value in the measured particle size distribution of the active material in the liquid composition.

The measurement method of the maximum particle diameter of the active material is not particularly limited and can be appropriately selected according to the intended purpose. For example, the measurement can be performed according to ISO13320:2009. The device used for the measurement is not particularly limited and can be appropriately selected according to the intended purpose. Examples of the device include, but are not limited to, a laser diffraction particle size distribution measurement device (Mastersizer 3000, manufactured by Malvern Panalytical Ltd.).

### [Mode Diameter of Active Material]

The mode diameter of the active material in the present embodiment is not particularly limited as long as the effects of the present embodiment are not impaired, and can be appropriately selected according to the intended purpose. However, the mode diameter is preferably 0.5 μm or more and 10 μm or less, and more preferably 3 μm or more and 10 μm or less. When the mode diameter of the active material is 0.5 μm or more and 10 μm or less, discharge defects are less likely to occur when the liquid composition is discharged by a liquid discharging method. Furthermore, when the mode diameter of the active material is 3 μm or more and 10 μm or less, an electrode composite layer with better electrical properties can be obtained. Note that the mode diameter is the diameter at which the measured particle size distribution of the active material in the liquid composition becomes maximum.

The measurement method of the mode diameter of the active material is not particularly limited and can be appropriately selected according to the intended purpose. For example, the measurement can be performed according to ISO13320:2009. The device used for the measurement is not particularly limited and can be appropriately selected according to the intended purpose. Examples of the device include, but are not limited to, a laser diffraction particle size distribution measurement device (Mastersizer 3000, manufactured by Malvern Panalytical Ltd.).

The content of the active material in the liquid composition is preferably 10% by mass or more, and more preferably 15% by mass or more. When the content of the active material in the liquid composition is 10% by mass or more, the number of times of printing that is needed for forming an electrode composite layer with a predetermined basis weight is reduced.

### <<Solid Electrolyte>>

The solid electrolyte is not particularly limited as long as it has electronic insulating properties and exhibits ionic conductivity, and can be appropriately selected according to the intended purpose.

Herein, having electronic insulating properties means a state in which a short circuit does not occur when the positive electrode and the negative electrode are opposed to each other via the solid electrolyte layer. Further, exhibiting ionic conductivity means that only ions move when a potential difference is applied when the positive electrode and the negative electrode are opposed to each other via the solid electrolyte layer.

The solid electrolyte is not particularly limited as long as the solid electrolyte is a solid material that has electronic insulating properties and exhibits ionic conductivity. However, from the viewpoint of the ionic conductivity, sulfide solid electrolytes containing sulfur in the composition formula, or oxide solid electrolytes containing only oxygen as an anion are preferable, and from the viewpoint of being able to form a good interface, sulfide solid electrolytes are more preferable.

The sulfide solid electrolyte is preferably a compound that contains a sulfur atom (S), has the ionic conductivity of a metal belonging to the group 1 or the group 2 of the periodic table, and has electronic insulating properties. A sulfide-based inorganic solid electrolyte preferably contains at least Li, S, and P as elements and has lithium ion conductivity. However, depending on the intended purpose or case, additional elements other than Li, S, and P may be included.

Examples of the sulfide solid electrolyte include, but are not limited to, a lithium ion conductive inorganic solid electrolyte that satisfies the composition represented by the following formula (1).

Lₐ₁M_{b1}P_{c1}S_{d1}Aₑ₁ (1)

In the formula (1), L represents an element selected from Li, Na, K, and Ca, and is preferably Li. M represents an element selected from B, Zn, Sn, Si, Cu, Ga, Sb, Al, Ge, and Y A represents an element selected from I, Br, Cl, and F. The values a1 to e1 represent the composition ratio of each element, and a1:b1:c1:d1:e1 satisfies 1 to 12:0 to 5:1:2 to 12:0 to 10.

The value of a1 is preferably 1 to 9, and more preferably 1.5 to 7.5.

The value of b1 is preferably 0 to 3, and more preferably 0 to 1.

The value of d1 is preferably 2.5 to 10, and more preferably 3.0 to 8.5.

The value of e1 is preferably 0 to 5, and more preferably 0 to 3.

The composition ratio of each element can be controlled by adjusting the blending ratio of the raw material compounds when producing the sulfide solid electrolyte as described below. The sulfide solid electrolyte may be amorphous (a glass) or crystalline (a glass ceramic), or only partially crystalline. For example, an Li—P—S glass containing Li, P, and S, or an Li—P—S glass ceramic containing Li, P, and S can be used. The sulfide solid electrolyte can be produced by a reaction between at least two raw materials among, for example, lithium sulfide (Li₂S), phosphorus sulfide (such as diphosphorus pentasulfide (P₂S₅)), elemental phosphorus, elemental sulfur, sodium sulfide, hydrogen sulfide, lithium halide (such as LiI, LiBr, and LiCl), and sulfides of the elements represented by M above (such as SiS₂, SnS, and GeS₂).

The ratio of Li₂S and P₂S₅ in the Li—P—S glass and the Li—P—S glass ceramic in terms of the molar ratio of Li₂S:P₂S₅ is preferably 60:40 to 90:10, and more preferably 68:32 to 78:22. By setting the ratio of Li₂S and P₂S₅ within the ranges above, the lithium ion conductivity can be made high. Specifically, the lithium ion conductivity can be preferably set to 1×10⁻⁴ S/cm or more, and more preferably set to 1×10⁻³ S/cm or more. Although there is no particular upper limit, it is practical to set the lithium ion conductivity to 5×10⁻¹ S/cm or less.

Examples of combinations of raw materials are shown below as specific examples of sulfide solid electrolytes. Examples include, but are not limited to, Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂SP₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂SSiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁oGeP₂S₁₂. However, the mixing ratio of each of the raw materials is not specified. Examples of the method of synthesizing the sulfide solid electrolyte material using such raw material compositions include, but are not limited to, an amorphization method. Examples of the amorphization method include, but are not limited to, a mechanical milling method, a solution method, and a melt quenching method. This is because processing at room temperature becomes possible and the production process can be simplified.

The oxide solid electrolyte is preferably a compound that contains an oxygen atom (O), has the ionic conductivity of a metal belonging to group 1 or group 2 of the periodic table, and has electronic insulating properties.

Examples of specific compounds include, but are not limited to, LiₓₐLa_{ya}TiO₃ [xa=0.3-0.7, ya=0.3-0.7] (LLT), Li_{xb}La_{yb}Zr_{zb}Mbb_{mb}O_{nb} (Mbb represents one or more elements among Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}MCC_{zc}O_{nc} (Mcc represents one or more elements among C, S, Al, Si, Ga, Ge, In, and Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (where 1≤xd≤3, 0≤yd≤1, 0≤zd≤2, 0≤ad≤1, 1≤md≤7, 3≤nd 13), Li(₃₋₂ₓₑ)MeeₓₑDeeO (xe represents a number from 0 or more and 0.1 or less, Mee represents a divalent metal atom, Dee represents a halogen atom or a combination of two or more halogen atoms), Li_{xf}Si_{yf}O_{zf} (1≤xf≤5, 0<yf≤3, 1≤zf≤10), Li_{xg}S_{yg}O_{zg} (1≤xg≤3, 0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO(_{4-3/2w})N_{w} (w satisfies w<1), Li_{3.5}Zn_{0.25}GeO₄ having a LISICON (lithium super ionic conductor) type crystal structure, La_{0.55}Li_{0.35}TiO₃ having a perovskite type crystal structure, LiTi₂P₃O₁₂ having a NASICON (natrium super ionic conductor) type crystal structure, Li_{1+xh+yh}(Al, Ga)ₓₕ(Ti, Ge)_{2-Xh}Si_{yh}P_{3-yh}O₁₂ (where 0≤xh≤1, 0≤yh≤1), and Li₇La₃Zr₂O₁₂ (LLZ) having a garnet type crystal structure. Also desirable are phosphorus compounds containing Li, P and O. Examples include, but are not limited to, lithium phosphate (Li₃PO₄), LiPON in which some of the oxygen in the lithium phosphate has been replaced with nitrogen, LiPOD1 (where D1 is at least one selected from Ti, V, Cr, Mn, Fe, Co, Ni, Cu, Zr, Nb, Mo, Ru, Ag, Ta, W, Pt, and Au). Furthermore, LiAlON (where Al is at least one selected from Si, B, Ge, Al, C, and Ga) can also be preferably used.

The maximum particle diameter of the solid electrolyte is not particularly limited as long the effects of the present embodiment are not impaired, and can be appropriately selected according to the intended purpose. However, if an inkjet printing application is assumed, the maximum particle diameter is preferably smaller than the nozzle diameter of the inkjet head, and is preferably sufficiently smaller than the nozzle diameter of the inkjet head from the viewpoint of further improving the inkjet discharging properties. Specifically, the ratio between the maximum particle diameter of the solid electrolyte contained in the liquid composition and the nozzle diameter of the inkjet head (maximum particle diameter of solid electrolyte contained in liquid composition/nozzle diameter of inkjet head) is preferably 0.8 or less, more preferably 0.6 or less, and even more preferably 0.5 or less. When the maximum particle diameter of the solid electrolyte is within these ranges, the discharging stability of the liquid composition is improved. For example, in the case of a droplet observation device (EV1000, manufactured by Ricoh Co., Ltd.), the nozzle diameter is 40 μm. Here, the maximum particle diameter of the active material contained in the liquid composition is preferably 32 μm or less, more preferably 24 μm or less, and even more preferably 20 μm or less. Note that the maximum particle diameter is the diameter that is the maximum value in the measured particle size distribution of the solid electrolyte in the liquid composition.

The measurement method of the maximum particle diameter of the solid electrolyte is not particularly limited and can be appropriately selected according to the intended purpose. Examples include, but are not limited to, the same methods as the measurement methods of the maximum particle diameter of the active material described above.

The mode diameter of the solid electrolyte is not particularly limited as long as the effects of the present embodiment are not impaired, and can be appropriately selected according to the intended purpose. However, the mode diameter is preferably 0.1 μm or more and 10 μm or less, and more preferably 0.5 μm or more and 3 μm or less. When the mode diameter of the solid electrolyte is 0.1 μm or more and 10 μm or less, discharge defects are less likely to occur when the liquid composition is discharged by a liquid discharging method. Note that the mode diameter is the diameter at which the measured particle size distribution of the solid electrolyte in the liquid composition becomes maximum.

The measurement method of the mode diameter of the solid electrolyte is not particularly limited and can be appropriately selected according to the intended purpose. Examples include, but are not limited to, the same methods as the measurement methods of the mode diameter of the active material described above.

### <<Solvent>>

The solvent is not particularly limited as long as it dissolves the binder, and can be appropriately selected according to the intended purpose. Examples of the solvent include, but are not limited to, ketones such as acetone, methyl ethyl ketone, and cyclohexanone; esters such as ethyl acetate, butyl acetate, and lactic acid ester; ethers such as diethyl ether, dioxane, and tetrahydrofuran; amide-based polar organic solvents such as N,N-dimethylformamide and N-methyl-2-pyrrolidone (NMP); and aromatic hydrocarbons such as toluene, xylene, and anisole. These solvents may be used alone or in combination of two or more. Among these solvents, esters, ethers, and aromatic hydrocarbons are preferable as aprotic organic solvents that do not react with the sulfide solid electrolyte.

### <<Dispersant>>

The dispersant is not particularly limited as long as it can improve the dispersibility of the active material in the liquid composition, and can be appropriately selected according to the intended purpose. Examples of the dispersant include, but are not limited to, polymeric dispersants such as polyethylene oxide-based, polypropylene oxide-based, polycarboxylic acid-based, naphthalene sulfonic acid-formalin condensation-type, polyethylene glycol-based, polycarboxylic acid partial alkyl ester-type, polyether-based, and polyalkylene polyamine-based dispersants; low-molecular weight dispersants such as alkyl sulfonic acid-based, quaternary ammonium-based, higher-alcohol alkylene oxide-based, polyhydric alcohol ester-based, and alkyl polyamine-based dispersants; and inorganic dispersants such as polyphosphate-based dispersants. These dispersants may be used alone or in combination of two or more.

The content of the dispersant in the liquid composition is not particularly limited and can be appropriately selected according to the intended purpose. However, in terms of the solid concentration of the dispersant, because aggregation can result when the solid concentration of the dispersant is too high, the content is preferably 10% by mass or less and more preferably 3% by mass or less with respect to the active material to be dispersed or the total amount of the active material and the solid electrolyte.

### <<Other Components>>

The other components are not particularly limited as long as the effects of the present embodiment are not impaired, and can be appropriately selected according to the intended purpose. Examples of the other component include, but are not limited to, a conductive aid.

### Conductive Aid

Examples of the conductive aid that can be used include, but are not limited to, conductive black produced by a furnace method, an acetylene method, and a gasification method, and carbon materials such as carbon nanofibers, carbon nanotubes, graphene, and graphite particles. Examples of conductive aids other than carbon materials that can be used include, but are not limited to, metal particles and metal fibers of aluminum. Note that the conductive aid may be combined in advance with the active material.

The upper limit of the mass ratio of the conductive aid to the active material is preferably 10% by mass or less, more preferably 5% by mass or less, even more preferably 3% by mass or less, and the lower limit is preferably 1% by mass or more. When the mass ratio of the conductive aid to the active material is the lower limit or more, the conductivity of the resulting electrode composite layer is further improved. When the mass ratio of the conductive aid to the active material is the upper limit or less, the conductivity of the resulting electrode composite layer is not impaired, and the energy density can be further improved.

### <Viscosity of Liquid Composition>

The viscosity of the liquid composition at 25° C. is preferably such that the liquid composition can be discharged from a liquid discharging head. The upper limit of the viscosity is preferably 200 mPa·s or less, more preferably 100 mPa·s or less, and even more preferably 50 mPa·s or less. Furthermore, the lower limit of the viscosity is preferably 10 mPa·s or more, and more preferably 30 mPa·s or more. As a result of the viscosity being the lower limit or more, flow is suppressed in the step of drying the applied liquid composition, and unevenness in the film thickness caused by the drying and composition variations are suppressed.

### <Liquid Composition Production Method>

The liquid composition can be produced by dissolving or dispersing each of the above components in the solvent.

Specifically, the liquid composition can be prepared by mixing each of the above components and the solvent using a mixer such as a ball mill, a sand mill, a bead mill, a pigment dispersion machine, a grinder, an ultrasonic dispersion machine, a homogenizer, a planetary mixer, or a Filmix.

### <Liquid Composition for Forming Solid Electrolyte Layer>

The liquid composition for forming a solid electrolyte layer contains a solid electrolyte, a binder, and a solvent, and other additional components if preferable.

### <<Solid Electrolyte>>

As the solid electrolyte, the same solid electrolytes as those of the liquid composition for forming an electrode composite layer described above can be used.

The content of the solid electrolyte in the liquid composition is not particularly limited and can be appropriately selected according to the intended purpose. However, the content is preferably 20% by mass or more based on the total amount of the liquid composition from the viewpoint of the productivity, and preferably 50% by mass or less based on the total amount of the liquid composition from the viewpoint of the discharging properties by the inkjet method.

### <<Binder>>

The binder of the present embodiment described above is used as the binder.

The binder is preferably blended within a mass concentration range that dissolves in the solvent.

The binder is a component that does not excessively increase the viscosity of the liquid composition. Furthermore, in a laminated body produced by forming the solid electrolyte layer on an electrode using the liquid composition, the binder is a component that holds the components included in the solid electrolyte layer so as to not separate from the laminated body.

### <<Solvent>>

In recent years, all-solid state batteries that use solid electrolytes instead of flammable electrolytic solutions have been sought for the purpose of providing lithium ion secondary batteries with improved safety. Among solid electrolytes, sulfide solid electrolytes, which have a particularly high ionic conductivity and good properties, generate hydrogen sulfide when coming into contact with protic solvents. Furthermore, it is known that sulfide solid electrolytes decompose in highly polar solvents such as NMP. Therefore, when preparing a slurry of the sulfide solid electrolyte, it is preferable to use a low polarity, aprotic solvent that does not damage the sulfide solid electrolyte. As aprotic organic solvents that do not react with the sulfide solid electrolyte, esters, ethers, and aromatic hydrocarbons are preferable.

The content of the solvent in the liquid composition is not particularly limited and can be appropriately selected according to the intended purpose. However, the content is preferably 40% by mass or more based on the total amount of the liquid composition from the viewpoint of the discharging properties by the inkjet method, and preferably 80% by mass or less based on the total amount of the liquid composition from the viewpoint of the productivity.

### <<Dispersant>>

The dispersant is used to disperse the solid electrolyte.

The dispersant is not particularly limited as long as it can disperse the solid electrolyte. However, from the viewpoint of dispersibility, a dispersant having an ionic adsorption group is preferred. Furthermore, it is preferable that the dispersant is a material that does not easily react with the solid electrolyte. Herein, and in the claims, a material that does not easily react with the solid electrolyte refers to a material that exhibits a low rate of change in the ionic conductivity of the solid electrolyte when the solid electrolyte and the material are mixed and left for a certain period of time. The rate of change in the ionic conductivity is preferably 3% or less, more preferably 1% or less, and even more preferably 0%.

The dispersant is not particularly limited and can be appropriately selected according to the intended purpose, and examples include, but are not limited to, polymeric dispersants such as polyethylene-based, polyethylene oxide-based, polypropylene oxide-based, polycarboxylic acid-based, naphthalene sulfonic acid-formalin condensation-type, polyethylene glycol-based, polycarboxylic acid partial alkyl ester-type, polyether-based, and polyalkylene polyamine-based dispersants; low-molecular weight dispersants such as alkyl sulfonic acid-based, quaternary ammonium-based, higher-alcohol alkylene oxide-based, polyhydric alcohol ester-based, and alkyl polyamine-based dispersants; and inorganic dispersants such as polyphosphate-based dispersants. These dispersants may be used alone or in combination of two or more.

The content of the dispersant in the liquid composition is not particularly limited, and can be appropriately selected according to the intended purpose. However, the upper limit is preferably 5% by mass or less, more preferably 3% by mass or less, and even more preferably 1% by mass or less with respect to the solid electrolyte, and the lower limit is preferably 0.1% by mass or more. When the content of the dispersant is within the preferable range, the dispersion stability of the solid electrolyte can be ensured without impairing the surface functionality of the solid electrolyte.

### <<Other Components>>

The other components are not particularly limited as long as the effects of the present embodiment are not impaired, and can be appropriately selected according to the intended purpose.

### (Electrode)

The electrode according to the present embodiment (hereinafter sometimes referred to as “secondary battery electrode”) includes an electrode base and at least one of an electrode composite layer and a solid electrolyte layer on the electrode base.

At least one of the electrode composite layer and the solid electrolyte layer contains the binder of the present embodiment. That is, at least one of the electrode composite layer and the solid electrolyte layer is formed using the liquid composition of the present embodiment.

The electrode composite layer contains the positive electrode active material and the binder, and preferably contains the solid electrolyte and the dispersant. In addition, each component contained in the electrode composite layer is contained in the liquid composition, and the preferable abundance ratio of each component is the same abundance ratio of each component in the liquid composition.

The solid electrolyte layer contains the solid electrolyte and the binder, and preferably contains the dispersant. In addition, each component contained in the solid electrolyte layer is contained in the liquid composition, and the preferable abundance ratio of each component is the same abundance ratio of each component in the liquid composition.

Because the electrode of the present embodiment uses the liquid composition of the present embodiment, at least one of the electrode composite layer and the solid electrolyte layer having a high peel strength can be preferably formed on the electrode base.

### <Electrode Base (Current Collector)>

As the material constituting the electrode base, a material that is electrically conductive and electrochemically durable is used. Specifically, as the electrode base, for example, an electrode base made of iron, copper, aluminum, nickel, stainless steel, titanium, tantalum, gold, or platinum can be used. Note that the materials mentioned above may be used alone or in combination of two or more in any ratio.

### <Electrode Production Method>

The electrode production method of the present embodiment includes a step of applying the liquid composition of the present embodiment onto the electrode base, and includes other additional steps if preferable.

The application method of the liquid composition is not particularly limited. Examples of the application method include, but are not limited to, a liquid discharging method such as an inkjet method, a spray coating method, and a dispenser method; a spin coating method, a casting method, a micro gravure coating method, a gravure coating method, a bar coating method, a roll coating method, a wire bar coating method, a dip coating method, a slit coating method, a capillary coating method, a nozzle coating method, a gravure printing method, a screen printing method, a flexographic printing method, an offset printing method, and a reverse printing method. Among these methods, the inkjet method is particularly preferable. By using the inkjet method, an electrode can be produced in any shape in a non-contact manner. As a result, there is an effect such as little loss of the active material caused by die punching in the electrode production process. At this time, the liquid composition may be applied to only one side of the current collector, or may be applied to both sides. The thickness of the liquid composition on the current collector after coating and before drying can be appropriately set according to the thickness of the electrode composite layer obtained by drying.

The method of drying the liquid composition on the electrode base is not particularly limited, and a known method can be used. Examples of the method include, but are not limited to, a drying method using warm air, hot air, and low humidity air, a vacuum drying method, and a drying method using irradiation with infrared rays or an electron beam. By drying the liquid composition on the electrode base in this way, the electrode composite layer can be formed on the electrode base, and an electrode including the electrode base and the electrode composite layer can be obtained.

### (Laminated Body of Solid Electrolyte Layer and Electrode)

A laminated body of a solid electrolyte layer and an electrode according to the present embodiment includes an electrode and a solid electrolyte layer formed on the electrode. The solid electrolyte layer is formed using the liquid composition of the present embodiment. That is, the solid electrolyte layer contains the solid electrolyte, the dispersant, and the binder. In addition, each component contained in the solid electrolyte layer is contained in the liquid composition, and the preferable abundance ratio of each component is the same abundance ratio of each component in the liquid composition.

Because the laminated body of the present embodiment uses the liquid composition of the present embodiment, the solid electrolyte layer having a high peel strength can be preferably formed on the electrode.

Note that the solid electrolyte layer can be formed in the same manner as the electrode production method described above, except that the solid electrolyte layer is formed on the electrode.

### (Storage Container)

A storage container of the present embodiment is a storage container that accommodates the liquid composition of the present embodiment described above.

The shape, structure, and size of the storage container are not particularly limited and can be appropriately selected according to the intended purpose.

The electrode production method of an electrode of an electrochemical element specifically performed using an inkjet method will be described below.

### (Electrochemical Element Production Device and Electrochemical Element Production Method)

An electrochemical element production device of the present embodiment includes the storage container of the present embodiment described above, and a discharge unit that discharges the liquid composition that is accommodated in the storage container using an inkjet head (sometimes also referred to as “liquid discharging head”), and includes other additional configurations if preferable.

An electrochemical element production method of the present embodiment includes an application step of applying the liquid composition of the present embodiment described above using an inkjet head, and includes other additional steps if preferable.

### <Application Unit and Application Step>

The application unit is a unit that applies the liquid composition that is accommodated in the storage container using, for example, an inkjet head.

The application step is a step of applying the liquid composition using, for example, an inkjet head.

As a result of the application, the liquid composition is applied onto a target object, and a liquid composition layer can be formed.

The target object (hereinafter, sometimes also referred to as “application target object”) is not particularly limited as long as the target object forms at least one of the electrode composite layer and the solid electrolyte layer, and can be appropriately selected according to the intended purpose. Examples of the target object include, but are not limited to, the electrode base and the electrode composite layer.

### <Other Configurations and Other Steps>

The other configurations of the electrochemical element production device are not particularly limited as long as the effects of the present embodiment are not impaired, and can be appropriately selected according to the intended purpose. Examples of the other configurations include, but are not limited to, a heating unit.

The other steps of the electrochemical element production method are not particularly limited as long as the effects of the present embodiment are not impaired, and can be appropriately selected according to the intended purpose. Examples of the other steps include, but are not limited to, a heating step.

### Heating Unit and Heating Step

The heating unit is a unit that heats the liquid composition that has been applied by the application unit.

The heating step is a step of heating the liquid composition that has been applied by the application step.

The liquid composition layer can be dried by the heating.

### [Embodiment for Forming Electrode by Direct Application of Liquid Composition to Base Material]

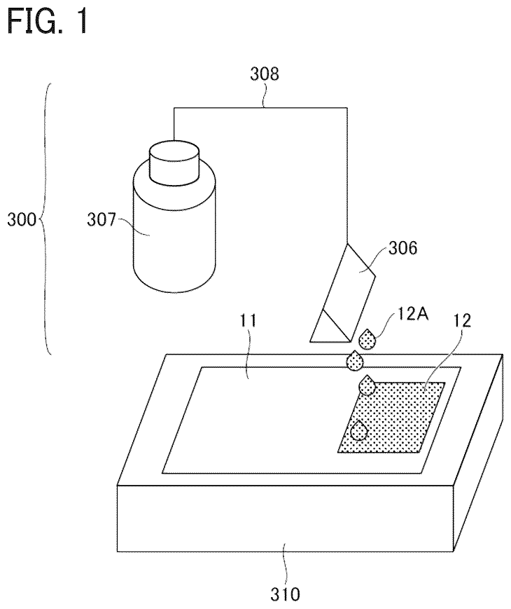

FIG. 1 is a schematic diagram illustrating an electrode production method according to the present embodiment.

A liquid composition 12A is stored in a tank 307 of a liquid discharging device 300, and is supplied from the tank 307 to a liquid discharging head 306 via a tube 308. The number of liquid discharging devices is not limited to one, and may be two or more.

When producing an electrode, after installing an electrode base 11 on a stage 310, droplets of the liquid composition 12A are discharged from the liquid discharging head 306 onto the electrode base 11. At this time, the stage 310 may be moved, or the liquid discharging head 306 may be moved. The applied liquid composition 12A becomes the electrode composite layer and/or the solid electrolyte layer 12.

Furthermore, the liquid discharging device 300 may be provided with a mechanism that caps the nozzle to avoid becoming dry when the liquid composition 12A is not being applied from the liquid discharging head 306.

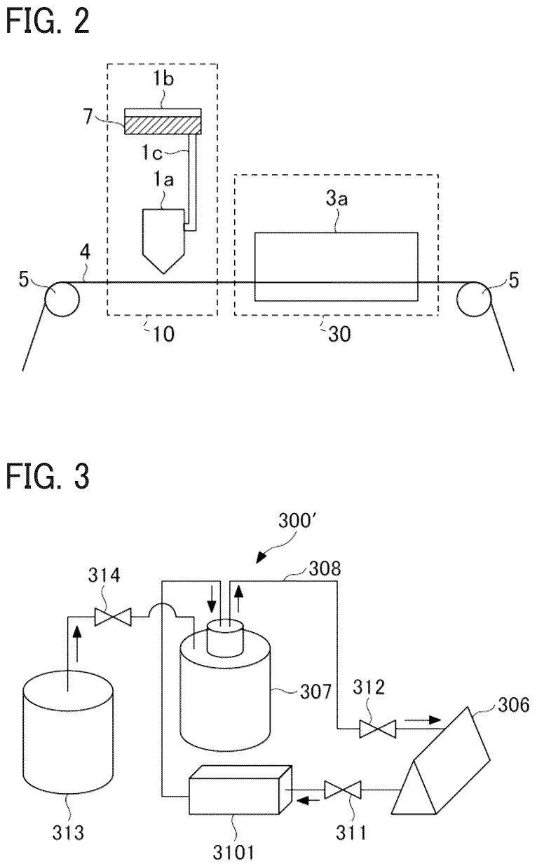

FIG. 2 is a schematic diagram illustrating an electrode production device for implementing the electrode production method of the present embodiment.

The electrode production device in FIG. 2 is a device that produces at least one of the solid electrolyte layer and the electrode composite layer using the liquid composition described above. The electrode production device includes a discharging step unit 10 that performs a step of applying the liquid composition to form the liquid composition layer on a printing base material 4 having the application target object thereon, and a heating step unit 30 that performs a heating step of heating the liquid composition layer to form at least one of the electrode composite layer and the solid electrolyte layer. The electrode production device includes a transport unit 5 that transports the printing base material 4. The transport unit 5 transports the printing base material 4 through the discharging step unit 10 and the heating step unit 30 in this order at a preset speed.

The production method of the printing base material 4 having the application target object thereon, such as the electrode base or the electrode composite layer, is not particularly limited, and known methods can be appropriately selected.

The discharging step unit 10 includes a printing device 1a that performs an inkjet printing method, which is an application unit that performs the application step of applying the liquid composition onto the printing base material 4, a storage container 1b that accommodates the liquid composition, and a supply tube 1c that supplies the liquid composition that is stored in the storage container 1b to the printing device 1a.

The storage container 1b accommodates a liquid composition 7. The discharging step unit 10 discharges the liquid composition 7 from the printing device 1a, and applies the liquid composition 7 onto the printing base material 4 to form the liquid composition layer in the form of a thin film. Note that the storage container 1b may be integrated with the electrode production device, or may be detachable from the electrode production device. Furthermore, the storage container 1b may be a container used to add to a storage container that is integrated with the electrode production device, or a storage container that is detachable from the electrode production device.

The storage container 1b and the supply tube 1c can be selected arbitrarily as long as the storage container 1b and the supply tube 1c are capable of stably storing and supplying the liquid composition 7.

As shown in FIG. 2, the heating step unit 30 includes a heating device 3a, and performs a solvent removal step of drying and removing the solvent remaining in the liquid composition layer by heating by the heating device 3a. As a result, the electrode composite layer and/or solid electrolyte layer can be formed. The heating step unit 30 may perform the solvent removal step under a reduced pressure.

The heating device 3a is not particularly limited and can be appropriately selected according to the intended purpose. Examples of the heating device 3a include, but are not limited to, substrate heating, an IR heater, and a hot air heater, and a combination of these devices may be used.

Furthermore, the heating temperature and time can be appropriately selected according to the boiling point of the solvent included in the liquid composition 7 and the thickness of the film that has been formed.

FIG. 3 is a schematic diagram illustrating another electrode production device (liquid discharging device) for implementing the electrode production method of the present embodiment.

The liquid discharging device 300′ is capable of circulating the liquid composition through the liquid discharging head 306, the tank 307, and the tube 308 by controlling a pump 3101 and valves 311 and 312.

In addition, the liquid discharging device 300′ is provided with an external tank 313. When the amount of the liquid composition in the tank 307 decreases, it is also possible to supply the liquid composition from the external tank 313 to the tank 307 by controlling the pump 3101 and the valves 311, 312 and 314.

When the electrode production device is used, the liquid composition can be discharged onto a targeted location of the application target object.

The solid electrolyte layer and/or electrode composite layer can be preferably used, for example, as a portion of the configuration of the electrochemical element. The configurations other than the solid electrolyte layer and/or electrode composite layer of the electrochemical element are not particularly limited, and known configurations can be appropriately selected. Examples of the other configurations include, but are not limited to, a positive electrode, a negative electrode, and a separator.

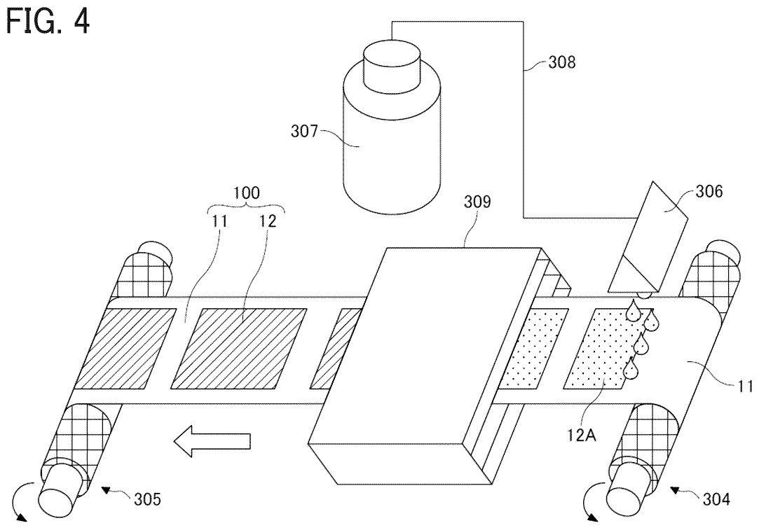

FIG. 4 is a diagram illustrating an electrode production method of the present embodiment.

The production method of an electrode 100 includes a step of sequentially discharging the liquid composition 12A onto the electrode base 11 using the liquid discharging device 300′.

First, the electrode base 11 having an elongated shape is prepared. Then, the electrode base 11 is wound around a cylindrical core, and is set on a feed roller 304 and a take-up roller 305 such that the side on which the electrode composite layer 12 is to be formed faces upward in FIG. 4. Here, the feed roller 304 and the take-up roller 305 rotate counterclockwise, and the electrode base 11 is transported from right to left in FIG. 4.

Then, in a similar manner to FIG. 1, droplets of the liquid composition 12A are discharged from the liquid discharging head 306, which is installed above the electrode base 11 between the feed roller 304 and the take-up roller 305, onto the electrode base 11 that is successively transported.

Note that a plurality of the liquid discharging heads 306 may be installed in a direction that is substantially parallel or substantially orthogonal to the transport direction of the electrode base 11. Then, the electrode base 11 onto which droplets of the liquid composition 12A have been discharged is transported to a heating mechanism 309 by the feed roller 304 and the take-up roller 305. As a result, the electrode composite layer 12 is formed, and the electrode 100 is obtained. Then, the electrode 100 is cut into a desired size by a punching process or the like.

The heating mechanism 309 may be installed either above or below the electrode base 11, and a plurality of the heating mechanisms 309 may be installed.

The heating mechanism 309 is not particularly limited as long as the heating mechanism 309 does not make direct contact with the liquid composition 12A. Examples of the heating mechanism 309 include, but are not limited to, a resistance heater, an infrared heater, and a fan heater. A plurality of the heating mechanisms 309 may be installed. Furthermore, a curing device using ultraviolet rays for polymerization may be installed.

Moreover, the liquid composition 12A discharged onto the electrode base 11 is preferably heated. At the time of heating, the liquid composition 12A may be heated by a stage, or by a heating mechanism other than a stage. The heating mechanism may be installed either above or below the electrode base 11, and a plurality of the heating mechanisms may be installed.

The heating temperature is not particularly limited. The liquid composition 12A is dried and the electrode composite layer is formed as a result of the heating.

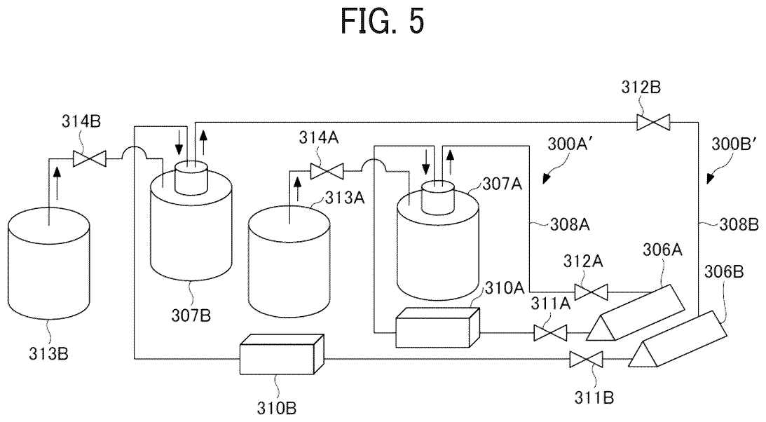

Furthermore, as shown in FIG. 5, the tank 307 may be supplied with ink from tanks 313A and 313B that are connected to tanks 307A and 307B. In addition, the liquid discharging head 306 may include a plurality of heads 306A and 306B.

### [Embodiment for Forming Electrode by Indirect Application of Liquid Composition to Base Material]

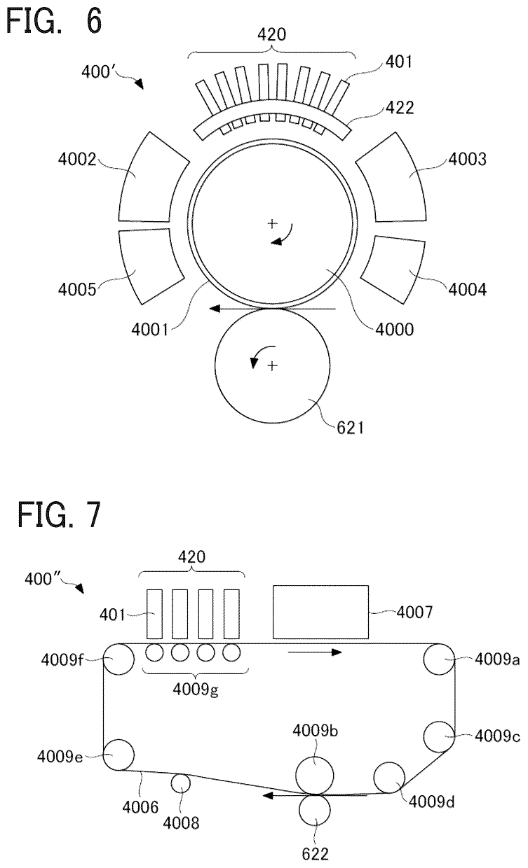

FIGS. 6 and 7 are configuration diagrams illustrating examples of printing units adopting an inkjet method and a transfer method as the application unit of the electrode production device of the present embodiment. FIG. 6 is a configuration diagram illustrating a printing unit using a drum-shaped intermediate transfer body. FIG. 7 is a configuration diagram illustrating a printing unit using an endless belt-shaped intermediate transfer body.

The printing unit 400′ illustrated in FIG. 6 is an inkjet printer that forms an electrode composite layer and/or solid electrolyte layer on a base material by transferring a liquid composition layer onto the base material via an intermediate transfer body 4001.

The printing unit 400′ includes an inkjet unit 420, a transfer drum 4000, a pretreatment unit 4002, an absorption unit 4003, a heating unit 4004, and a cleaning unit 4005.

The inkjet unit 420 includes a head module 422 holding a plurality of heads 401. The heads 401 discharge the liquid composition onto the intermediate transfer body 4001 supported on the transfer drum 4000 to form the liquid composition layer on the intermediate transfer body 4001. Each of the heads 401 is a line head, and nozzles are arrayed in a range covering the width of a recording region of a base material having the maximum usable size. The heads 401 each include, on a lower surface, a nozzle surface formed with nozzles. The nozzle surface faces a surface of the intermediate transfer body 4001 via a small gap. In the case of the present embodiment, the intermediate transfer body 4001 is configured to move so as to circulate on a circular path. Therefore, the plurality of heads 401 are radially arranged.

The transfer drum 4000 faces an impression cylinder 621 and forms a transfer nip portion. For example, before the heads 401 discharge the liquid composition, the pretreatment unit 4002 applies a reaction liquid for increasing the viscosity of the liquid composition onto the intermediate transfer body 4001. The absorption unit 4003 absorbs the liquid component from the liquid composition layer on the intermediate transfer body 4001 before the transfer. The heating unit 4004 heats the liquid composition layer on the intermediate transfer body 4001 before the transfer. The liquid composition layer is dried as a result of being heated, and the electrode composite layer and/or solid electrolyte layer is formed. Furthermore, the organic solvent is removed, and the transferability onto the base material is improved. The cleaning unit 4005 cleans the intermediate transfer body 4001 after the transfer, and removes foreign matter such as the liquid composition or dust remaining on the intermediate transfer body 4001.

The outer peripheral surface of the impression cylinder 621 is in pressure contact with the intermediate transfer body 4001. When the base material passes through the transfer nip portion between the impression cylinder 621 and the intermediate transfer body 4001, the liquid composition layer on the intermediate transfer body 4001 is transferred onto the base material. Note that the impression cylinder 621 may include at least one gripping mechanism that holds the front end portion of the base material on the outer circumferential surface of the impression cylinder 621.

The printing unit 400″ illustrated in FIG. 7 is an inkjet printer that forms an electrode composite layer and/or solid electrolyte layer on a base material by transferring a liquid composition layer onto the base material via an intermediate transfer belt 4006.

The printing unit 400″ discharges droplets of the liquid composition from the plurality of heads 401 provided in the inkjet unit 420 to form a liquid composition layer on an outer peripheral surface of the intermediate transfer belt 4006. The liquid composition layer formed on the intermediate transfer belt 4006 is heated and dried by a heating unit 4007, which forms the electrode composite layer and/or solid electrolyte layer as a film on the intermediate transfer belt 4006.

At the transfer nip portion where the intermediate transfer belt 4006 faces a transfer roller 622, the liquid composition layer formed as a film on the intermediate transfer belt 4006 is transferred to the base material. After the transfer, the surface of the intermediate transfer belt 4006 is cleaned by a cleaning roller 4008.

The intermediate transfer belt 4006 is stretched over a drive roller 4009a, a counter roller 4009b, a plurality (four in this example) of shape maintaining rollers 4009c, 4009d, 4009e and 4009f, and a plurality (four in this example) of support rollers 4009g, and is moved in the direction of the arrows in FIG. 7. The support rollers 4009g provided facing the heads 401 maintain a tensed state of the intermediate transfer belt 4006 when ink droplets are discharged from the heads 401.

### <Negative Electrode>

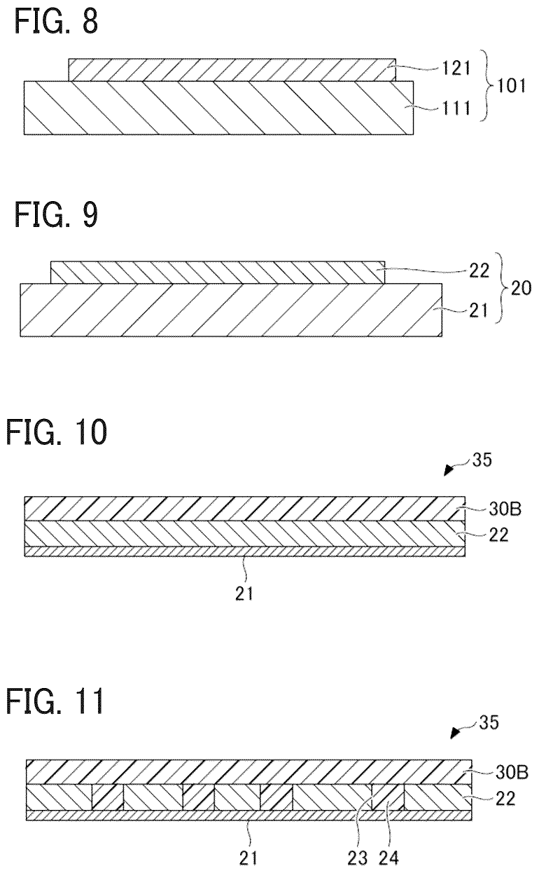

FIG. 8 is a diagram illustrating a negative electrode of the present embodiment.

In the negative electrode 101, a negative electrode composite layer 121 is formed on one side of a negative electrode base 111. The shape of the negative electrode 100 is not particularly limited and can be appropriately selected according to the intended purpose. Examples of the shape include, but are not limited to, a flat plate shape. Examples of the material forming the negative electrode base 111 include, but are not limited to, stainless steel, nickel, aluminum, and copper.

Note that the negative electrode composite layer 121 may be formed on both sides of the negative electrode base 111.

Furthermore, an adhesive layer containing a metal that alloys with lithium may be provided between the negative electrode base 111 and the negative electrode composite layer 121. The adhesive layer is preferably provided on the negative electrode.

The negative electrode can be produced using the electrode production device described above.

### <Positive Electrode>

FIG. 9 is a diagram illustrating a positive electrode of the present embodiment.

In the positive electrode 20, a positive electrode composite layer 22 is formed on one side of a positive electrode base 21. The shape of the positive electrode 20 can be appropriately selected according to the intended purpose. Examples of the shape include, but are not limited to, a flat plate shape.

Examples of the material forming the positive electrode base 21 include, but are not limited to, stainless steel, aluminum, titanium, and tantalum.

Note that the positive electrode composite layer 22 may be formed on both sides of the positive electrode base 21.

The positive electrode can be produced using the electrode production device described above.

### (Electrochemical Element)

The electrochemical element of the present embodiment includes an electrode of the present embodiment, and includes other additional configurations if preferable.

The electrochemical element can include a separator and an exterior in addition to the positive electrode, the negative electrode, and the solid electrolyte layer or electrolytic solution. The electrochemical element has at least one of the positive electrode, the negative electrode, and the solid electrolyte layer formed using the liquid composition of the present embodiment.

Note that the separator is not necessary when using a solid electrolyte or a gel electrolyte.

The electrode base (current collector) is the same as the electrode base (current collector) described above.

The active material, the solid electrolyte, the binder, and the dispersant are the same as the active material, the solid electrolyte, the binder, and the dispersant in the liquid composition described above.

Note that the electrochemical element of the present embodiment preferably uses the electrode of the present embodiment as the positive electrode. Furthermore, although a lithium ion secondary battery will be described below as an example of the electrochemical element, the present embodiment is not limited to the following example.

### <Electrode>

The electrodes other than the electrode of the present embodiment above that can be used in the secondary battery are not particularly limited, and known electrodes used in the production of secondary batteries can be used. Specifically, an electrode formed by an electrode composite layer on an electrode base using a known production method can be used.

FIG. 10 is a cross-sectional view of an electrode of the present embodiment. An electrode 35 includes a positive electrode base 21, a positive electrode composite layer 22 disposed on the positive electrode base 21, and a porous insulating layer 30B disposed on the positive electrode composite layer 22.

FIG. 11 is a cross-sectional view of an electrode of the present embodiment. As shown in FIG. 11, the positive electrode composite layer 22 provided in the electrode 35 may have opening portions 23. The number of opening portions is preferably one or more, and is preferably more than one. The opening portions may pass through the positive electrode composite layer 22 from the surface of the positive electrode composite layer 22 to the surface of the positive electrode base 21, but does not have to pass through to the surface of the positive electrode base 21.

The opening portions may be hollow or may be filled with a material 24. Here, the material 24 may be used alone or in a mixture of two or more. In either case, the material filled in the opening portions is a different compound or has a different composition to the material constituting the positive electrode composite layer 22.

An electrode composite layer having opening portions can be preferably produced by using an inkjet as an electrode composite layer forming unit because the coating control is simple.

Furthermore, in the electrodes shown in FIGS. 10 and 11, an adhesive layer containing a metal that alloys with lithium may be provided between the positive electrode base 21 and the positive electrode composite layer 22.

### <Electrolyte>

The electrolytes other than the solid electrolyte layer of the present embodiment above that can be used in the secondary battery are not particularly limited, and known solid electrolyte layers or electrolytic solutions used in the production of secondary batteries can be used.

### [Electrolytic Solution]

As the electrolytic solution, an organic electrolytic solution in which a supporting electrolyte is dissolved in an organic solvent is usually used. For example, a lithium salt is used as a supporting electrolyte of a lithium ion secondary battery. Examples of the lithium salt include, but are not limited to, LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)NLi. Among these lithium salts, LiPF₆, LiClO₄ and CF₃SO₃Li are preferable because these lithium salts are readily soluble in solvents and exhibit a high degree of dissociation, and LiPF₆ is more preferable. Note that the electrolyte may be used alone or in combination of two or more in any ratio. Usually, the lithium ion conductivity tends to increase as a supporting electrolyte with a higher degree of dissociation is used. Therefore, the lithium ion conductivity can be adjusted depending on the type of supporting electrolyte.

The organic solvent used in the electrolytic solution is not particularly limited as long as the solvent can dissolve the supporting electrolyte. Examples of the organic solvent that can be preferably used include, but are not limited to, carbonates such as dimethyl carbonate (DMC), ethylene carbonate (EC), diethyl carbonate (DEC), propylene carbonate (PC), butylene carbonate (BC) and ethylmethyl carbonate (EMC); esters such as γ-butyrolactone and methyl formate; ethers such as 1,2-dimethoxyethane and tetrahydrofuran; and sulfur-containing compounds such as sulfolane and dimethyl sulfoxide. Furthermore, a mixture of these solvents may be used. Among these solvents, it is preferable to use carbonates because carbonates have a high dielectric constant and a wide stable potential range. Further, it is more preferable to use a mixture of ethylene carbonate and diethyl carbonate.

Note that the concentration of the electrolyte in the electrolytic solution can be adjusted as appropriate. In addition, known additives such as vinylene carbonate can be added to the electrolytic solution.

### <Separator>

The separator is not particularly limited and can be selected as appropriate according to the intended purpose. Examples of the separator include, but are not limited to, paper such as kraft paper, vinylon mixed paper, and synthetic pulp mixed paper; polyolefin nonwoven fabrics such as cellophane, polyethylene graft films, polypropylene melt-blown nonwoven fabrics; polyamide nonwoven fabrics, glass fiber nonwoven fabrics, and micropore films.

### <Exterior>

The exterior is not particularly limited as long as the exterior can seal the electrode, the electrolyte, and the separator or solid electrolyte or gel electrolyte.

### (Electrochemical Element Production Device and Electrochemical Element Production Method)

An electrochemical element production device of the present embodiment includes an electrode production unit that produces an electrode using the electrode production device of the present embodiment described above, and includes other additional configurations if preferable.

An electrochemical element production method of the present embodiment includes a step of producing an electrode by the electrode production method of the present embodiment described above, and includes other additional configurations if preferable.

The electrochemical element production device and the electrochemical element production method of the present embodiment may be appropriately selected from known units and methods, as long as the using the electrode production unit and the step of producing the electrode described above are those of the present embodiment.

The electrochemical element of the present embodiment can be produced by, for example, stacking a positive electrode and a negative electrode via a separator, winding or folding the stacked structure into a preferable battery shape and placing the stacked structure into a battery container, and then injecting an electrolytic solution into the battery container and sealing the battery container.

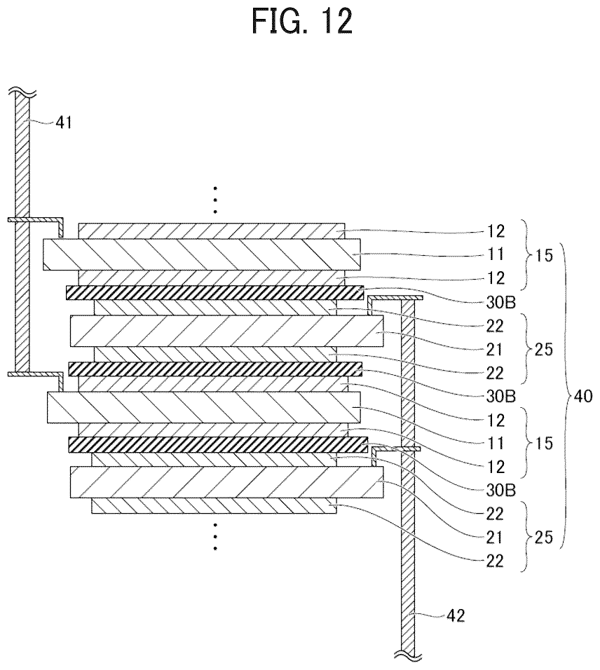

FIG. 12 is a diagram illustrating an electrode element used in an electrochemical element according to the present embodiment.

In an electrode element 40, negative electrodes 15 and positive electrodes 25 are laminated via separators 30B. Here, the positive electrodes 25 are laminated on both sides of the negative electrodes 15. Furthermore, a lead wire 41 is connected to the negative electrode bases 11, and a lead wire 42 is connected to positive electrode bases 21.

In the case of a solid electrochemical element, the separators 30B may be replaced with a solid electrolyte or a gel electrolyte.

The negative electrodes 15 are formed with negative electrode composite layers 12 on both sides of the negative electrode base 11.

The positive electrodes 25 are formed with positive electrode composite layers 22 on both sides of the positive electrode base 21.

Note that the number of laminated negative electrodes 15 and positive electrodes 25 in the electrode element 40 is not particularly limited. The number of negative electrodes 15 and the number of positive electrodes 25 in the electrode element 40 may be the same or different.

### <Electrochemical Element>

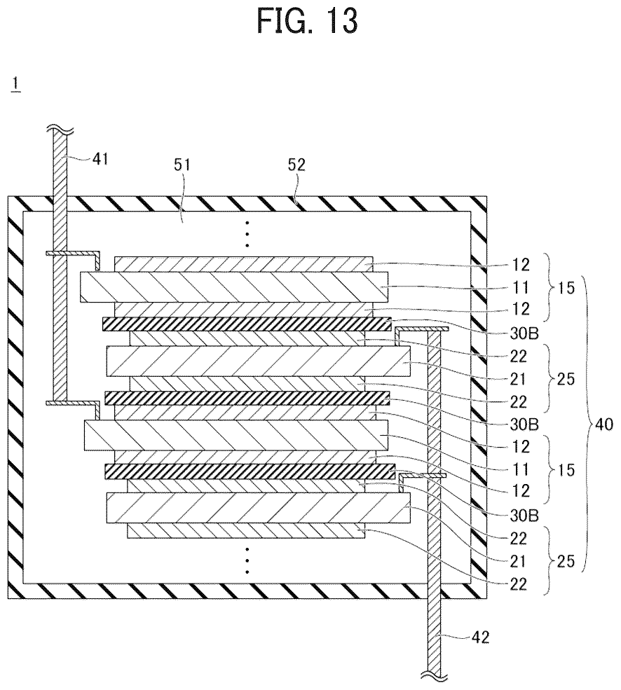

FIG. 13 is a diagram illustrating an electrochemical element according to the present embodiment.

When an electrochemical element 1 is a liquid-based electrochemical element, an electrolyte layer 51 is formed by injecting an electrolyte aqueous solution or a non-aqueous electrolyte into the electrode element 40, which is sealed by an exterior 52. In the electrochemical element 1, the lead wires 41 and 42 are drawn out of the exterior 52.

When the electrochemical element 1 is a solid electrochemical element, the separators 30B are replaced with a solid electrolyte or a gel electrolyte.

The shape of the electrochemical element 1 is not particularly limited. Examples of the shape include, but are not limited to, a laminate type, a cylinder type in which a sheet electrode and a separator are spirally formed, a cylinder type with an inside-out structure in which a pellet electrode and a separator are combined, and a coin type in which a pellet electrode and a separator are laminated.

### <Applications of Electrochemical Element>

The applications of the electrochemical element are not particularly limited. Examples of applications include, but are not limited to, moving bodies such as vehicles; and electric devices such as smartphones, laptop computers, pen-input personal computers, mobile personal computers, electronic book readers, mobile phones, portable fax machines, portable copying machines, portable printers, stereo headphones, video players, liquid crystal televisions, handheld vacuum cleaners, portable CD players, MiniDisc players, transceivers, electronic diaries, calculators, memory cards, portable tape recorders, radios, backup power supplies, motors, lighting devices, toys, game consoles, clocks, electronic flashes, and cameras. Among these products, vehicles and electrical devices are particularly preferable.

Examples of the moving body include, but are not limited to, ordinary automobiles, large-sized special automobiles, small-sized special automobiles, trucks, large-sized motorcycles, and ordinary motorcycles.

### [Moving Body]

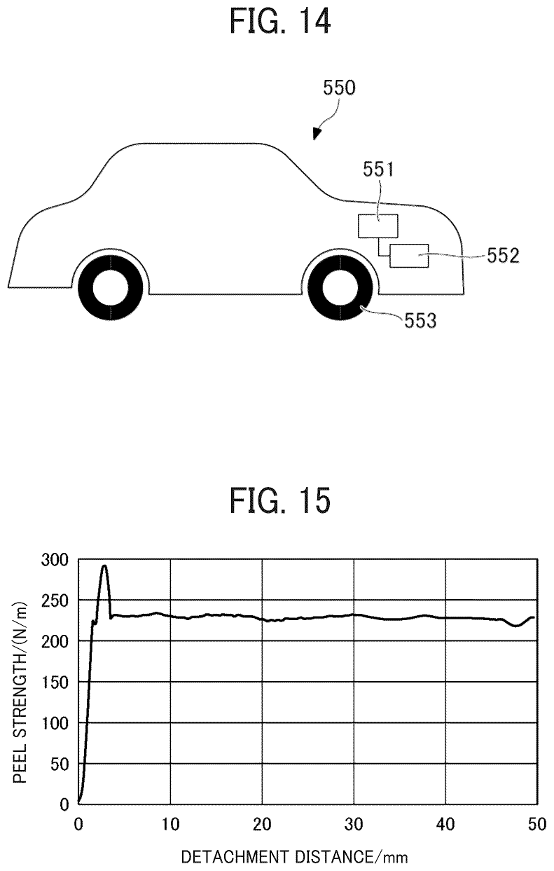

FIG. 14 is a diagram illustrating a moving body installed with an all-solid state battery, which is an example of an electrochemical element of the present embodiment. A moving body 550 is, for example, an electric vehicle. The moving body 550 includes a motor 551, an electrochemical element 552, and wheels 553, which are an example of a moving unit. The electrochemical element 552 is the electrochemical element of the present embodiment described above. The electrochemical element 552 drives the motor 551 by supplying electric power to the motor 551. The driven motor 551 can drive the wheels 553, and as a result, the moving body 550 can move.

According to the configuration above, because the moving body is driven by electric power from the electrochemical element having a superior peel strength, the moving body can be safely moved.

The moving body 550 is not limited to being an electric vehicle, and may be a plug-in hybrid vehicle (PHEV), a hybrid vehicle (HEV), a locomotive that can run using both a diesel engine and the electrochemical element, or a motorcycle. In addition, the moving body may be a transport robot used in a factory or the like, which can move by using only the electrochemical element or by using both an engine and the electrochemical element.

Furthermore, the moving body may be a moving body that does not move as a whole, and has only a portion that moves. For example, the moving body may be an assembly robot disposed on a production line of a factory, in which an arm or the like of the assembly robot can be moved by using only the electrochemical element or both an engine and the electrochemical element.

### EXAMPLES

Examples according to the present embodiment will be described below. However, the present embodiment is in no way limited to these Examples.

In the following Examples and Comparative Examples, the peel strength, cutting resistance, and bending resistance of the prepared positive electrodes for a secondary battery were measured and evaluated as described below.

### <Peel Strength>

The positive electrodes for a secondary battery prepared in the Examples and Comparative Examples were cut out into a rectangular shape with a length of 100 mm and a width of 30 mm, and used as test pieces. A cellophane tape (compliant with JIS Z1522) was attached to the surface of the test piece on the side having the positive electrode composite layer. Then the stress was measured when one end of the current collector was pulled in a vertical direction at a pulling speed of 30 mm/min and 50 mm was peeled off. The average value over a detachment distance of 10 to 50 mm was calculated as the peel strength, which was evaluated based on the following criteria. The evaluation criteria A to C below are pass levels. Note that the larger the peel strength value, the better the adhesion.

### [Evaluation Criteria]

A: Peel strength is 200 N/m or more
B: Peel strength is 100 N/m or more and less than 200 N/m
C: Peel strength is 50 N/m or more and less than 100 N/m
D: Peel strength is less than 50 N/m

### <Cutting Resistance>

The positive electrodes for a secondary battery prepared in the Examples and Comparative Examples were cut out into a rectangular shape with length of 50 mm and a width of 30 mm using a Thomson-type cutter (manufactured by Wista Co. Ltd., trimming cutter C69) having a Thomson blade. At the time of cutting, the cut surface was visually observed for chipping and peeling, and evaluated according to the following criteria. The evaluation criteria “good” and “fair” are pass levels.

### [Evaluation Criteria]

Good: No chipping or peeling
Fair: Chipping or peeling less than 1 mm in size
Poor: Chipping or peeling 1 mm or more in size

### <Bending Resistance>

The rectangular test pieces with a length of 50 mm and a width of 30 mm that were cut out in the evaluation of the cutting resistance above were wound around cylindrical metal rods with different diameters. Then, the occurrence of cracks in the positive electrode composite layer and/or peeling of the positive electrode composite layer from the current collector was visually observed. The minimum diameter (mm) of the metal rod in which cracking and/or peeling of the positive electrode composite layer occurred was recorded, and evaluated according to the following criteria. The evaluation criteria A to C are pass levels.

### [Evaluation Criteria]

A: Diameter of metallic rod when cracking and/or peeling occurred is less than 4 mm
B: Diameter of metallic rod when cracking and/or peeling occurred is 4 mm or more and less than 6 mm
C: Diameter of metallic rod when cracking and/or peeling occurred is 6 mm or more and less than 10 mm
D: Diameter of metallic rod when cracking and/or peeling occurred is 10 mm or more

### Example 1

### Synthesis of poly(butyl methacrylate-co-2-dimethylaminoethyl methacrylate) (P-1)

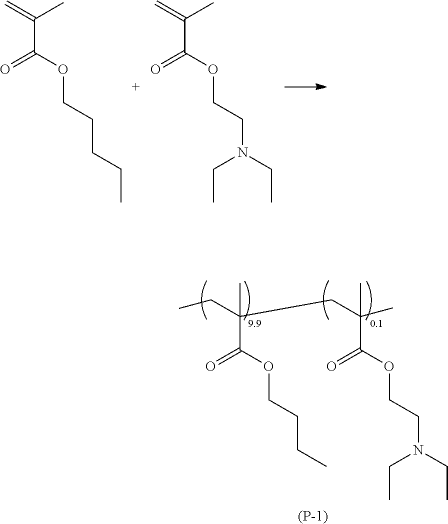

The binder (P-1) was synthesized as follows.

Under a nitrogen stream, 30 mL of degassed toluene was added to a 200 mL flask and heated to 80° C. Then, a mixed solution composed of 35.00 g (246.1 mmol) of butyl methacrylate, 5.07 g (27.34 mmol) of 2-(dimethylamino)ethyl methacrylate, and 135.8 mg (0.547 mmol) of 2,2′-azobis(2,4-dimethylvaleronitrile) was added dropwise over 1 hour with stirring, and after the dropwise addition was completed, the mixture was stirred at 80° C. for 8 hours. After cooling to room temperature, the reaction solution was added dropwise to methanol, the precipitate was collected by decantation and dried under a vacuum to obtain 16.46 g of the random copolymer binder (P-1). The binder (P-1) had a Tg of 22° C. (DSC), and a weight average molecular weight of 64,000. The copolymerization ratio of the binder (P-1) estimated from the 1H-NMR spectrum was approximately the molar ratio that was charged. Note that the subscripts in parentheses of the binder (P-1) represent the molar ratio of the constituent components.

### Example 2

### Synthesis of poly(butyl methacrylate-co-2-diethylaminoethyl methacrylate) (P-2)

By the same method as in Example 1, 33 mL of toluene, 25.00 g (175.8 mmol) of butyl methacrylate, 8.14 g (43.95 mmol) of 2-(diethylamino)ethyl methacrylate, and 109 mg (0.440 mmol) of 2,2′-azobis(2,4-dimethylvaleronitrile) were used to prepare 14.46 g of the binder (P-2). The binder (P-2) had a Tg of 16° C. (DSC), and a weight average molecular weight of 62,800. The copolymerization ratio of the binder (P-2) estimated from the 1H-NMR spectrum was approximately the molar ratio that was charged. Note that the subscripts in parentheses in the formula of the binder (P-2) represent the molar ratio of the constituent components.

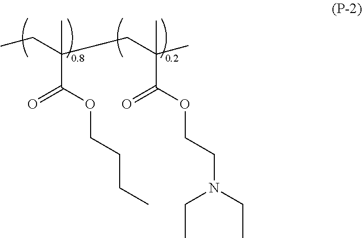

### Example 3

### Synthesis of poly(butyl methacrylate-co-2-diethylaminoethyl methacrylate) (P-3)

By the same method as in Example 1, 40 mL of toluene, 26.00 g (182.8 mmol) of butyl methacrylate, 14.52 g (78.36 mmol) of 2-(diethylamino)ethyl methacrylate, and 103 mg (0.414 mmol) of 2,2′-azobis(2,4-dimethylvaleronitrile) were used to prepare 22.50 g of the binder (P-3). The binder (P-3) had a Tg of 12° C. (DSC), and a weight average molecular weight of 65,200. The copolymerization ratio of the binder (P-3) estimated from the 1H-NMR spectrum was approximately the molar ratio that was charged. Note that the subscripts in parentheses in the formula of the binder (P-3) represent the molar ratio of the constituent components.

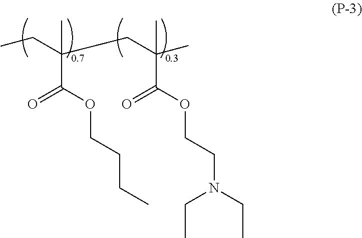

### Example 4

### Synthesis of poly(butyl methacrylate-co-2-diethylaminoethyl methacrylate) (P-4)

By the same method as in Example 1, 40 mL of toluene, 22.00 g (154.7 mmol) of butyl methacrylate, 19.11 g (103.1 mmol) of 2-(diethylamino)ethyl methacrylate, and 128 mg (0.516 mmol) of 2,2′-azobis(2,4-dimethylvaleronitrile) were used to prepare 21.02 g of the binder (P-4). The binder (P-4) had a Tg of 10° C. (DSC), and a weight average molecular weight of 61,900. The copolymerization ratio of the binder (P-4) estimated from the 1H-NMR spectrum was approximately the molar ratio that was charged. Note that the subscripts in parentheses in the formula of the binder (P-4) represent the molar ratio of the constituent components.

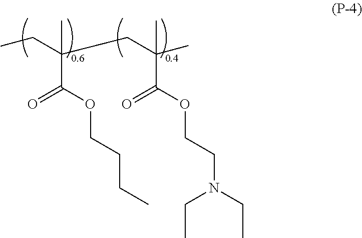

### Example 5

### Synthesis of poly(butyl methacrylate-co-2-diethylaminoethyl methacrylate) (P-5)

By the same method as in Example 1, a polymerization reaction was performed using 30 mL of toluene, 13.00 g (91.42 mmol) of butyl methacrylate, 16.94 g (91.42 mmol) of 2-(diethylamino)ethyl methacrylate, and 45 mg (1.828 mmol) of 2,2′-azobis(2,4-dimethylvaleronitrile). Then, the toluene was distilled off under a reduced pressure, and after further vacuum drying at 120° C., 21.02 g of the binder (P-5) was obtained. The binder (P-5) had a Tg of 1° C. (DSC), and a weight average molecular weight of 63,500. The copolymerization ratio of the binder (P-5) estimated from the 1H-NMR spectrum was approximately the molar ratio that was charged. Note that the subscripts in parentheses in the formula of the binder (P-5) represent the molar ratio of the constituent components.

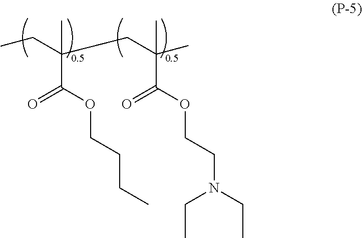

### Example 6

### Synthesis of poly(butyl methacrylate-co-2-dimethylaminoethyl methacrylate) (P-6)

By the same method as in Example 1, a polymerization reaction was performed using 40 mL of toluene, 20.00 g (140.6 mmol) of butyl methacrylate, 22.11 g (140.6 mmol) of 2-(dimethylamino)ethyl methacrylate, and 140 mg (0.562 mmol) of 2,2′-azobis(2,4-dimethylvaleronitrile). Then, reprecipitation purification was performed using hexane, and after further vacuum drying at 120° C., 23.85 g of the binder (P-6) was obtained.

The binder (P-6) had a Tg of 15° C. (DSC), and a weight average molecular weight of 64,600.

The copolymerization ratio of the binder (P-6) estimated from the 1H-NMVR spectrum was approximately the molar ratio that was charged. Note that the subscripts in parentheses in the formula of the binder (P-6) represent the molar ratio of the constituent components.

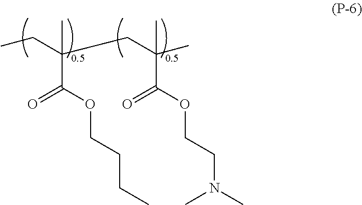

### Example 7

### Synthesis of poly(ethyl methacrylate-co-2-diethylaminoethyl methacrylate) (P-7)

By the same method as in Example 1, a polymerization reaction was performed using 40 mL of toluene, 16.05 g (140.6 mmol) of ethyl methacrylate, 22.11 g (140.6 mmol) of 2-(dimethylamino)ethyl methacrylate, and 140 mg (0.562 mmol) of 2,2′-azobis(2,4-dimethylvaleronitrile). Then, reprecipitation purification was performed using hexane, and after further vacuum drying at 120° C., 25.35 g of the binder (P-7) was obtained. The binder (P-7) had a Tg of 26° C. (DSC), and a weight average molecular weight of 55,000. The copolymerization ratio of the binder (P-7) estimated from the 1H-NMR spectrum was approximately the molar ratio that was charged. Note that the subscripts in parentheses in the formula of the binder (P-7) represent the molar ratio of the constituent components.

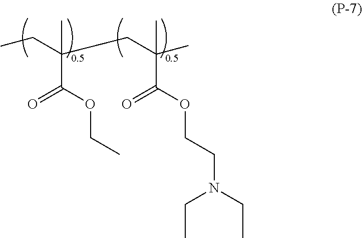

### Example 8

### Synthesis of poly(dimethylaminoethyl methacrylate) (P-8)

By the same method as in Example 1, 40 mL of toluene, 40.00 g (254.4 mmol) of 2-(dimethylamino)ethyl methacrylate, and 632 mg (2.54 mmol) of 2,2′-azobis(2,4-dimethylvaleronitrile) were used to obtain 32.25 g of the binder (P-8). The binder (P-8) had a Tg of 14° C. (DSC), and a weight average molecular weight of 58,000.

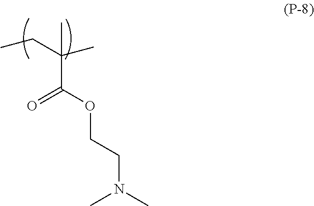

### Synthesis of poly(butyl methacrylate-co-2-dimethylaminoethyl methacrylate-co-2-diethylaminoethyl methacrylate) (P-9)

By the same method as in Example 1, 40 mL of toluene, 30.00 g (211.0 mmol) of butylmethacrylate, 4.15 g (26.38 mmol) of 2-(dimethylamino)ethyl methacrylate, 4.89 g (26.38 mmol) of 2-(diethylamino)ethyl methacrylate, and 131 mg (0.528 mmol) of 2,2′-azobis(2,4-dimethylvaleronitrile) were used to prepare 24.35 g of the binder (P-9). The binder (P-9) had a Tg of 22° C. (DSC), and a weight average molecular weight of 64,300. The copolymerization ratio of the binder (P-9) estimated from the 1H-NMR spectrum was approximately the molar ratio that was charged. Note that the subscripts in parentheses in the formula of the binder (P-9) represent the molar ratio of the constituent components.

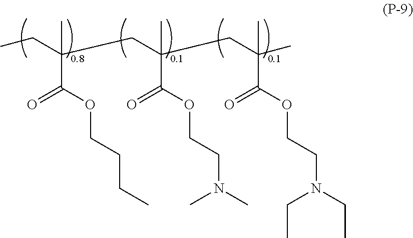

### Example 10

### Synthesis of poly(diethylaminoethyl methacrylate) (P-10)

By the same method as in Example 1, 40 mL of toluene, 36.18 g (254.4 mmol) of 2-(diethylamino)ethyl methacrylate, and 632 mg (2.54 mmol) of 2,2′-azobis(2,4-dimethylvaleronitrile) were used to obtain 25.46 g of the binder (P-10). The binder (P-10) had a Tg of −17° C. (DSC), and a weight average molecular weight of 61,300.

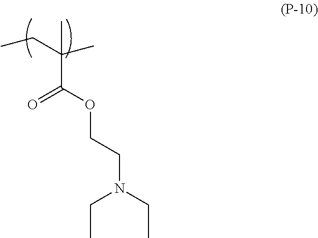

### Example 11

### Synthesis of poly(ethyl methacrylate-co-2-diethylaminoethyl methacrylate) (P-11)

By the same method as in Example 1, 40 mL of toluene, 14.08 g (140.6 mmol) of methyl methacrylate, 22.11 g (140.6 mmol) of 2-(dimethylamino)ethyl methacrylate, and 140 mg (0.562 mmol) 2,2′-azobis(2,4-dimethylvaleronitrile) were used to obtain 25.35 g of the binder (P-11). The binder (P-11) had a Tg of 40° C. (DSC), and a weight average molecular weight of 57,200.

The copolymerization ratio of the binder (P-11) estimated from the 1H-NMR spectrum was approximately the molar ratio that was charged. Note that the subscripts in parentheses in the formula of the binder (P-11) represent the molar ratio of the constituent components.

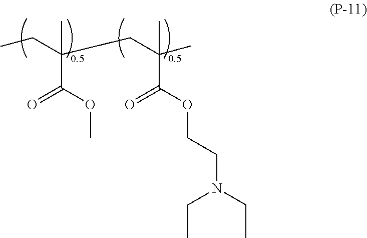

### Example 12

### Synthesis of poly(2-methoxyethyl methacrylate-co-2-diethylaminoethyl methacrylate) (P-12)

By the same method as in Example 1, 33 mL of toluene, 25.35 g (175.8 mmol) of 2-methoxyethyl methacrylate, 8.14 g (43.95 mmol) of 2-(diethylamino)ethyl methacrylate, and 109 mg (0.440 mmol) of 2,2′-azobis(2,4-dimethylvaleronitrile) were used to prepare 23.76 g of the binder (P-12). The binder (P-12) had a Tg of −1° C. (DSC), and a weight average molecular weight of 62,800. The copolymerization ratio of the binder (P-12) estimated from the 1H-NMR spectrum was approximately the molar ratio that was charged. Note that the subscripts in parentheses in the formula of the binder (P-12) represent the molar ratio of the constituent components.

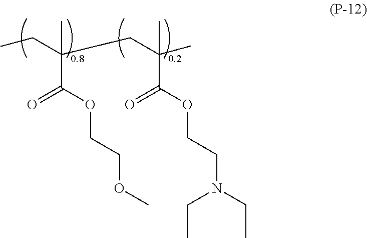

### Comparative Example 1

### Synthesis of polymethylmethacrylate (C-1)

Except for changing the 35.00 g (246.1 mmol) of butyl methacrylate and 5.07 g (27.34 mmol) of 2-(dimethylamino)ethyl methacrylate in Example 1 to 27.37 g (273.44 mmol) of methyl methacrylate, the binder (C-1) was obtained in the same manner as in Example 1. The binder (C-12) had a Tg of 100° C. (DSC), and a weight average molecular weight of 45,000.

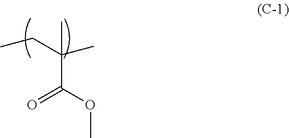

### Comparative Example 2

### Synthesis of polybutyl methacrylate (C-2)

Except for changing the 35.00 g (246.1 mmol) of butyl methacrylate and 5.07 g (27.34 mmol) of 2-(diethylamino)ethyl methacrylate in Example 1 to 38.88 g (273.44 mmol) of butyl methacrylate, the binder (C-2) was obtained in the same manner as in Example 1. The binder (C-2) had a Tg of 16° C. (DSC), and a weight average molecular weight of 64,000.

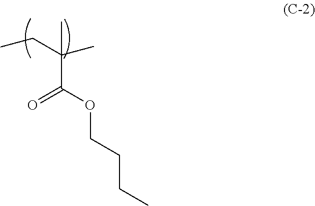

### Comparative Example 3

### Synthesis of poly(butyl methacrylate-co-methacrylate (C-3)

By the same method as in Example 1, 20 mL of toluene, 20.00 g (140.6 mmol) of butyl methacrylate, 1.345 g (15.63 mmol) of methacrylic acid, and 388 mg (1.563 mmol) of 2,2′-azobis(2,4-dimethylvaleronitrile) were used to prepare 15.35 g of the binder (C-3). The binder (C-3) had a Tg of 29° C. (DSC), and a weight average molecular weight of 23,500. Note that the subscripts in parentheses in the formula of the binder (C-3) represent the molar ratio of the constituent components. The copolymerization ratio of the binder (C-3) estimated from the 1H-NMR spectrum was approximately the molar ratio that was charged.

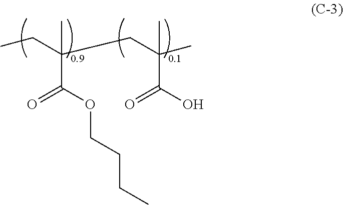

### Comparative Example 4

### Synthesis of poly(methyl methacrylate-co-methacrylate (C-4)

Except for changing the 35.00 g (246.1 mmol) of butyl methacrylate and 5.07 g (27.34 mmol) of 2-(diethylamino)ethyl methacrylate in Example 1 to 17.6 g (175.8 mmol) of methyl methacrylate and 3.78 g (43.95 mmol) of methacrylic acid, the binder (C-4) was obtained in the same manner as in Example 1. The binder (C-4) had a Tg of 95° C. (DSC), and a weight average molecular weight of 48,000. The copolymerization ratio of the binder (C-4) estimated from the 1H-NMR spectrum was approximately the molar ratio that was charged. Note that the subscripts in parentheses in the formula of the binder (C-4) represent the molar ratio of the constituent components.

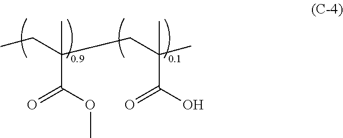

### Comparative Example 5

### Synthesis of poly(butyl methacrylate-co-methyl methacrylate (C-5)

Except for changing the 35.00 g (246.1 mmol) of butyl methacrylate and 5.07 g (27.34 mmol) of 2-(diethylamino)ethyl methacrylate in Example 1 to 35.00 g (246.1 mmol) of butyl methacrylate and 2.74 g (27.34 mmol) of methyl methacrylate, the binder (C-5) was obtained in the same manner as in Example 1. The binder (C-5) had a Tg of 40° C. (DSC), and a weight average molecular weight of 56,000. The copolymerization ratio of the binder (C-5) estimated from the 1H-NMR spectrum was approximately the molar ratio that was charged. Note that the subscripts in parentheses in the formula of the binder (C-5) represent the molar ratio of the constituent components.

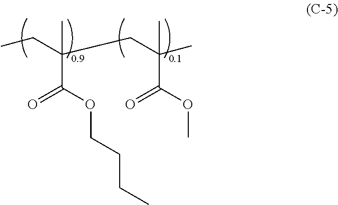

### Comparative Example 6

### Synthesis of poly(decyl methacrylate-co-2-diethylaminoethyl methacrylate) (C-6)

By the same method as in Example 1, 35.02 g of decyl methacrylate and 19.10 g of 2-(diethylamino)ethyl methacrylate were used to obtain the binder (C-6). The binder (C-6) had a Tg of −30° C. (DSC), and a weight average molecular weight of 57,200. The copolymerization ratio of the binder (C-6) estimated from the 1H-NMR spectrum was approximately the molar ratio that was charged. Note that the subscripts in parentheses in the formula of the binder (C-6) represent the molar ratio of the constituent components.

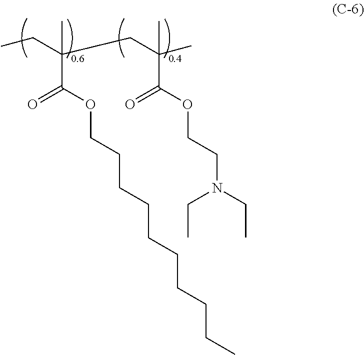

### Comparative Example 7

### Synthesis of poly(butyl methacrylate-co-2-aminoethyl methacrylate) (C-7)

By the same method as in Example 1, 25.00 g of butyl methacrylate and 5.68 g of 2-aminoethyl methacrylate were used to obtain the binder (C-7). The binder (C-7) had a Tg of 25° C. (DSC), and a weight average molecular weight of 60,200. The copolymerization ratio of the binder (C-7) estimated from the 1H-NMR spectrum was approximately the molar ratio that was charged. Note that the subscripts in parentheses in the formula of the binder (C-7) represent the molar ratio of the constituent components.

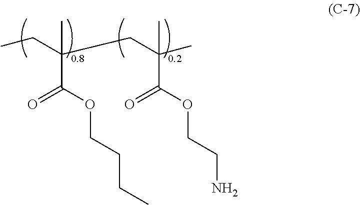

### Example 13

### Preparation of Liquid Composition for Positive Electrode

The liquid composition for a positive electrode was obtained by mixing 5 parts by mass of the binder (P-1) synthesized in Example 1, 100 parts by mass of a nickel-based positive electrode active material (hereinafter, also referred to as “NCM” below) (manufactured by Toshima Manufacturing Co., Ltd.), 5 parts by mass of acetylene black, 2.5 parts by mass of Solsperse 13940 as a dispersant (manufactured by Japan Lubrizol Co., Ltd.), and 39 parts by mass of methyl hexanoate, and processing the mixture in an ultrasonic homogenizer.

### Production of Positive Electrode for Secondary Battery

The obtained liquid composition for a positive electrode was coated using an applicator on an aluminum foil having a thickness of 20 μm serving as a current collector. Then, the coated film was dried in an oven at 120° C., and a positive electrode for a secondary battery having a positive electrode composite layer with an average thickness of 80 μm on the current collector was obtained.

The peel strength, cutting resistance, and bending resistance of the obtained positive electrode for a secondary battery were evaluated using the methods described above. The results are shown in Table 1. Furthermore, the measurement results of the peel strength of Example 13 are shown in FIG. 15.

### Examples 14 to 24 and Comparative Examples 8 to 14

Except for changing the type of binder in Example 13 as shown in Tables 1 to 3, the liquid compositions for a positive electrode of Examples 14 to 24 and Comparative Examples 8 to 14 were prepared in the same manner as the liquid composition for a positive electrode of Example 13.

The peel strength, cutting resistance, and bending resistance of the obtained positive electrodes for a secondary battery were evaluated using the methods described above. The results are shown in Tables 1 to 3.

### Example 25

### Preparation of Liquid Composition for Solid Electrolyte Layer

A liquid composition containing a solid electrolyte was prepared using an argyrodite-type sulfide solid electrolyte Li₆PS₅Cl (LPSC) synthesized according to the known literature “J. Power Sources. 2018, 396, 33-40”. As a solvent, anisole (manufactured by Tokyo Kasei Kogyo Co., Ltd.) was used that had been dehydrated using 3 A molecular sieves to 20 ppm or less as measured by a Karl Fischer water concentration meter. The liquid composition for a solid electrolyte layer was obtained by processing, using an ultrasonic homogenizer, a mixture composed of 100 parts by mass of the synthesized sulfide solid electrolyte layer, 1 part by mass of a dispersant (Solsperse 21000, manufactured by Lubrizol Co., Ltd.), and 5 parts by mass of the binder (P-1) added to 150 parts by mass of the solvent.

### Production of Solid Electrolyte Layer

The liquid composition for a solid electrolyte layer obtained as described above was coated using an applicator on an aluminum foil having a thickness of 20 μm serving as a current collector. Then, the coated film was dried in an oven at 120° C., and an electrode formed having a solid electrolyte layer with an average thickness of 50 μm on the current collector was obtained.

### Example 26

Except for changing the binder (P-1) in Example 25 to the binder (P-9), an electrode having a solid electrolyte layer with an average thickness of 50 μm formed on the current collector was formed in the same manner as in Example 25.

The peel strength, cutting resistance, and bending resistance of the obtained electrodes were evaluated using the methods described above. The results are shown in Table 4.

### Comparative Example 15

Except for changing the binder (P-1) in Example 25 to the binder (C-7), formation of a solid electrolyte layer was attempted in the same manner as in Example 25. However, the polymer of the binder (C-7) altered the characteristics of the solid electrolyte, such that a solid electrolyte layer could not be formed. Therefore, it was not possible to measure any of the evaluation items.

TABLE 1

| | | | Example 13 | Example 14 | Example 15 | Example 16 | Example 17 | Example 18 |
|---|---|---|---|---|---|---|---|---|
| Binder No. | | | Example 1 | Example 2 | Example 3 | Example 4 | Example 5 | Example 6 |
| | | | P-1 | P-2 | P-3 | P-4 | P-5 | P-6 |
| Binder composition | | | BMA: 0.9 | BMA: 0.8 | BMA: 0.7 | BMA: 0.6 | MMA: 0.5 | BMA: 0.5 |
| | | | DEAEMA: 0.1 | DMAEMA: 0.2 | DMAEMA: 0.3 | DMAEMA: 0.4 | DEAEMA: 0.5 | DMAEMA: 0.5 |
| Evaluation | Peel strength | | A | A | A | A | B | A |
| result | Cutting resistance | | Good | Good | Good | Good | Good | Good |
| | Bending | Diameter at | 1 mm | 0.5 mm | No cracking | No cracking | No cracking | 5 mm |
| | resistance | which cracking | | | even at 0.5 | even at 0.5 | even at 0.5 | |
| | | or peeling | | | mm | mm | mm | |
| | | occurred | | | | | | |
| | | Evaluation | A | A | A | A | A | B |

TABLE 2

| | | | Example 19 | Example 20 | Example 21 | Example 22 | Example 23 | Example 24 |
|---|---|---|---|---|---|---|---|---|
| Binder No. | | | Example 7 | Example 8 | Example 9 | Example 10 | Example 11 | Example 12 |
| | | | P-7 | P-8 | P-9 | P-10 | P-11 | P-12 |
| Binder composition | | | EMA: 0.5 | DMAEMA: 1 | BMA: 0.8 | DEAEMA: 1 | MMA: 0.5 | MEMA: 0.8 |
| | | | DMAEMA: 0.5 | | DMAEMA: 0.1 | | DEAEMA: 0.5 | DEAEMA: 0.2 |
| | | | | | DEAEMA: 0.1 | | | |
| Evaluation | Peel strength | | A | A | A | B | C | C |
| result | Cutting resistance | | Good | Good | Good | Good | Fair | Good |
| | Bending | Diameter at | 5 mm | No cracking | 0.5 mm | 0.5 mm | 8 mm | 1 mm |
| | resistance | which cracking | | even at 0.5 mm | | | | |
| | | or peeling | | | | | | |
| | | occurred | | | | | | |
| | | Evaluation | B | A | A | A | C | A |

TABLE 3

| | | | Comparative | Comparative | Comparative | Comparative | Comparative | Comparative | Comparative |
|---|---|---|---|---|---|---|---|---|---|
| | | | Example 8 | Example 9 | Example 10 | Example 11 | Example 12 | Example 13 | Example 14 |
| Binder No. | | | Comparative | Comparative | Comparative | Comparative | Comparative | Comparative | Comparative |
| | | | Example 1 | Example 2 | Example 3 | Example 4 | Example 5 | Example 6 | Example 7 |
| | | | C-1 | C-2 | C-3 | C-4 | C-5 | C-6 | C-7 |
| Binder composition | | | MMA: 1 | BMA: 1 | BMA: 0.9 | MMA: 0.9 | BMA: 0.9 | DEMA: 0.6 | BMA: 0.8 |
| | | | | | MA: 0.1 | MA :0.1 | MMA: 0.1 | DEAEM: 0.4 | AEM: 0.2 |
| Evaluation | Peel strength | | C | B | A | A | B | D | — |
| result | Cutting resistance | | Poor | Good | Fair | Poor | Fair | Good | — |
| | Bending | Diameter at | 25 mm | 8 mm | 20 mm | 32 mm | 12 mm | 0.5 mm | Film characteristics |
| | resistance | which cracking | | | | | | | changed and |
| | | or peeling | | | | | | | could not |
| | | occurred | | | | | | | be measured |
| | | Evaluation | D | C | D | D | D | A | — |

TABLE 4

| | | | Example 26 | Example 27 |
|---|---|---|---|---|
| Binder No. | | | Example 1 | Example 9 |
| | | | P-1 | P-9 |
| Binder composition | | | BMA: 0.9 | BMA: 0.8 |
| | | | DEAEMA: 0.1 | DMAEMA: 0.1 |
| | | | | DEAEMA: 0.1 |
| Evaluation | Peel strength | | A | A |
| result | Cutting resistance | | Good | Good |
| | Bending | Diameter at | 1 mm | 1 mm |
| | resistance | which cracking | | |
| | | or peeling | | |
| | | occurred | | |
| | | Evaluation | A | A |

From the results in Tables 1 to 2 and 4, the electrodes prepared with the liquid compositions of Examples 13 to 26 had good results in all of the peel strength, cutting resistance, and bending resistance.

On the other hand, from the results in Table 3, the electrodes prepared using the liquid compositions of Comparative Examples 8 to 14 were brittle with poor cutting resistance and bending resistance.

Therefore, it was found that the binders of Examples 1 to 12 can be preferably used as a liquid composition for producing lithium ion batteries.

For example, aspects according to the present embodiment are as follows.

A first aspect is a binder used in a liquid composition containing at least one of a positive electrode active material and a solid electrolyte, wherein the binder includes a structural unit (a) represented by general formula (I) below, and a structural unit (b) represented by general formula (II) below, and a composition ratio (a:b) of the structural unit (a) represented by the general formula (I) and the structural unit (b) represented by the general formula (II) ranges from “more than 0 mol %:less than 100 mol %” to “100 mol % or less: 0 mol % or more”.

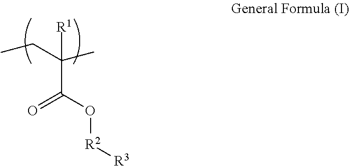

In the general formula (I), R¹ represents a hydrogen atom or an alkyl group, R² represents an alkylene group having 1 or more carbon atoms, and R³ represents a tertiary amino group.

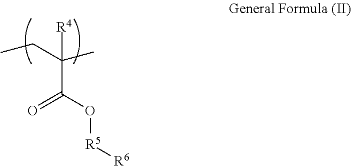

In the general formula (II), R⁴ represents a hydrogen atom or an alkyl group, R⁵ represents an alkylene group having 1 to 7 carbon atoms, both inclusive, or an alkylene oxide group having a total number of carbon and oxygen atoms of 1 or more and 7 or less, and R⁶ represents a hydrogen atom, a methyl group, or an ethyl group.

A second aspect is a liquid composition containing at least one of a positive electrode active material and a solid electrolyte, the binder according to the first aspect, and a solvent.

A third aspect is the liquid composition according to the second aspect, wherein the binder has a glass transition temperature of −30° C. or higher and less than 70° C.

A fourth aspect is the liquid composition according to the second aspect, wherein the positive electrode active material comprises at least one member selected from the group consisting of lithium-containing transition metal oxides and lithium-containing transition metal phosphate compounds.

A fifth aspect is the liquid composition according to the second aspect, wherein the positive electrode active material contains lithium.

A sixth aspect is the liquid composition according to the second aspect, wherein a content of the positive electrode active material is 10% by mass or more.

A seventh aspect is the liquid composition according to the second aspect, wherein the solid electrolyte is a sulfide solid electrolyte.

An eighth aspect is the liquid composition according to the second aspect, wherein the liquid composition has a viscosity of 200 mPa·s or less at 25° C.

A ninth aspect is the liquid composition according to the second aspect, wherein the liquid composition is an inkjet ink composition.

A tenth aspect is a storage container accommodating the liquid composition according to any one of the second to ninth aspects.

An eleventh aspect is an electrode production device comprising: the storage container according to the tenth aspect; and an application unit that applies the liquid composition accommodated in the storage container onto an electrode base.

A twelfth aspect is an electrode production method comprising applying the liquid composition according to any one of the second to ninth aspects onto an electrode base.

A thirteenth aspect is the electrode production method according to the twelfth aspect, further comprising pressurizing the electrode base to which the liquid composition has been applied.

A fourteenth aspect is an electrode comprising: an electrode base; and at least one of an electrode composite layer and a solid electrolyte layer on the electrode base; wherein the at least one of an electrode composite layer and a solid electrolyte layer contains the binder according to the first aspect.

A fifteenth aspect is an electrochemical element comprising the electrode according to the fourteenth aspect.

A sixteenth aspect is a device comprising the electrochemical element according to the fifteenth aspect.

A seventeenth aspect is a moving body comprising the electrochemical element according to the fifteenth aspect.

The conventional problems can be solved by any one of the binder according to the first aspect, the liquid composition according to any one of the second to ninth aspects, the storage container according to the tenth aspect, the electrode production device according to the eleventh aspect, the electrode production method according to the twelfth or thirteenth aspects, the electrode according to the fourteenth aspect, the electrochemical element according to the fifteenth aspect, the device according to the sixteenth aspect, and the moving body according to the seventeenth aspect. As a result, the object of the present invention can be achieved.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A binder used in a liquid composition containing at least one of a positive electrode active material and a solid electrolyte, the binder comprising:
a structural unit (a) represented by general formula (I) below: 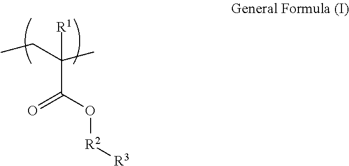
where, in the general formula (I), R¹ represents a hydrogen atom or an alkyl group, R² represents an alkylene group having 1 or more carbon atoms, and R³ represents a tertiary amino group; and
a structural unit (b) represented by general formula (II) below: 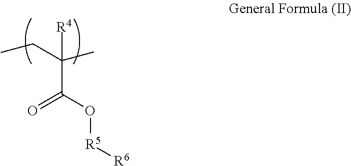
where, in the general formula (II), R⁴ represents a hydrogen atom or an alkyl group, R⁵ represents an alkylene group having 1 to 7 carbon atoms, both inclusive, or an alkylene oxide group having a total number of carbon and oxygen atoms of 1 or more and 7 or less, and R⁶ represents a hydrogen atom, a methyl group, or an ethyl group,
wherein a composition ratio (a:b) of the structural unit (a) represented by the general formula (I) and the structural unit (b) represented by the general formula (II) ranges from “more than 0 mol %:less than 100 mol %” to “100 mol % or less: 0 mol % or more”.

2. A liquid composition comprising:
at least one of a positive electrode active material and a solid electrolyte;
the binder according to claim 1; and
a solvent.

3. The liquid composition according to claim 2, wherein the binder has a glass transition temperature of −30° C. or higher and less than 70° C.

4. The liquid composition according to claim 2, wherein the positive electrode active material comprises at least one member selected from the group consisting of lithium-containing transition metal oxides and lithium-containing transition metal phosphate compounds.

5. The liquid composition according to claim 2, wherein the positive electrode active material contains lithium.

6. The liquid composition according to claim 2, wherein a content of the positive electrode active material is 10% by mass or more.

7. The liquid composition according to claim 2, wherein the solid electrolyte is a sulfide solid electrolyte.

8. The liquid composition according to claim 2, wherein the liquid composition has a viscosity of 200 mPa·s or less at 25° C.

9. The liquid composition according to claim 2, wherein the liquid composition is an inkjet ink composition.

10. A storage container accommodating the liquid composition according to claim 2.

11. An electrode production device comprising:
the storage container according to claim 10; and
an application unit that applies the liquid composition accommodated in the storage container onto an electrode base.

12. An electrode production method comprising applying the liquid composition according to claim 2 onto an electrode base.

13. The electrode production method according to claim 12, further comprising pressurizing the electrode base to which the liquid composition has been applied.

14. An electrode comprising:
an electrode base; and
at least one of an electrode composite layer and a solid electrolyte layer on the electrode base, the at least one of an electrode composite layer and a solid electrolyte layer containing the binder according to claim 1.

15. An electrochemical element comprising the electrode according to claim 14.

16. A device comprising the electrochemical element according to claim 15.

17. A moving body comprising the electrochemical element according to claim 15.
